(19) United States
(12) Patent Application Publication
(10) Pub. No.: US 2026/0347209 A1
(43) Pub. Date: Nov. 5, 2026

(54) PROCESSES TO SYNTHESIZE METAL OXIDE ELECTRODE MATERIALS FOR SODIUM ION BATTERIES

(71) Applicant: Boise State University, Boise, ID (US)

(72) Inventors: Hui Xiong, Boise, ID (US); Yifan Dong, Boise, ID (US); Jiacheng Hu, Boise, ID (US); Kincaid Graff, Boise, ID (US); Eric Gabriel, Boise, ID (US); Cyrus Koroni, Meridian, ID (US)

(73) Assignee: Boise State University, Boise, ID (US)

(21) Appl. No.: 19/641,135

(22) Filed: Apr. 7, 2026

Related U.S. Application Data
(60) Provisional application No. 63/784,563, filed on Apr. 7, 2025.
(60) Provisional application No. 63/806,430, filed on May 15, 2025.

(51) Int. Cl. C01G 53/51; C01G 49/00; H01M 4/505; H01M 10/054

(52) U.S. Cl. CPC C01G 53/51; C01G 49/0072; C01P 2002/72; C01P 2002/85; C01P 2004/03; C01P 2004/04; C01P 2006/17; C01P 2006/40; H01M 4/505; H01M 10/054

(57) ABSTRACT

Disclosed embodiments include utilizing the molten salt method to synthesize single crystalline NNMO (SC-NNMO) materials with enhanced electrochemical properties. One disclosed method may also include synthesizing an iron-manganese-based hydroxide precursor for a sodium-ion layered transition metal oxide, where during the synthesis of the iron-manganese-based hydroxide precursor, an oxalate is used as a chelating agent. A material may include an iron-manganese-based hydroxide precursor for a sodium-ion layered transition metal oxide synthesized using oxalate as a chelating agent.

### CROSS-REFERENCE TO RELATED APPLICATIONS

This application, under 35 U.S.C. § 119, claims the benefit of U.S. Provisional Patent Application Ser. No. 63/784,563 filed on Apr. 7, 2025, and entitled “Synthesis of Layered Transition Metal Oxide Cathode Materials via Molten Salt Method,” and U.S. Provisional Patent Application Ser. No. 63/806,430 filed on May 15, 2025, and entitled “Process to Synthesize Fe- and Mn-Based Layered Transition Metal Oxide Electrode Materials for Sodium Ion Batteries,” the contents of each of which are hereby incorporated by reference herein.

### GOVERNMENT LICENSE RIGHTS

This invention was made with government support under contract(s)/grant no(s). DE-SC0024404 and DE-SC0019121 awarded by the U.S. Department of Energy under the Basic Energy Sciences program. The government has certain rights in the invention.

### FIELD OF THE DISCLOSURE

This disclosure is generally related to the field of layered transition metal oxide electrode materials. More particularly, this disclosure relates to the synthesis of layered transition metal oxide cathode materials, including iron-(Fe) and manganese-(Mn) based layered transition metal oxides, via a molten salt and chelating agent methods.

### BACKGROUND

With the rapid proliferation of electric vehicles, the demand for high-energy, cost-effective battery systems have skyrocketed. While current lithium-ion based systems offer impressive energy density and stable cycling life, the raw materials needed to manufacture the positive electrode—namely lithium, nickel, and cobalt—have undergone significant price fluctuations. These fluctuations stem from their limited supply and concentrated geographical distribution resulting in fragile supply chains. Moreover, if global net-zero emission goals are to be achieved, these constraints could result in severe shortages unless supplementary chemistries are developed. Among these emerging candidates, Mn-/Fe-based layered transition metal oxide (LTMO) electrode materials for sodium-ion batteries stand as the most promising candidate economically due to their high material abundance, stable supply chains, and compatibility with current large-scale production infrastructure.

The current challenge in synthesizing the Fe and Mn-based LTMOs is associated with the control of the morphology of the precursors during co-precipitation. Current industrial production commonly employs the highly scalable coprecipitation method to synthesize transition metal (TM) hydroxide precursors. The coprecipitation process relies on the continuous dissolution and recrystallization of TM ions with either a chelating agent (typically ammonia) or hydroxide ions. This allows far greater control over particle morphology, size, and density that is not achievable with other synthesis methods. Conventional hydroxide precursor synthesis employs ammonia as the chelating agent, which benefits from decades of optimization in nickel-rich, nickel-manganese-cobalt, and nickel-manganese systems. Although effective in these chemistries, the Fe²⁺—NH₃ complex is not stable, causing it to readily decompose. This instability results in poor particle morphology, low tap density, and non-uniform elemental distribution-factors that undermine the viability of implementing this material in large-scale production.

As noted, layered transition metal oxide materials are among the most promising cathode materials for next-generation sodium ion batteries due to high energy density and cost-effectiveness. A typical method for synthesizing layered transition metal oxide materials may include solid state synthesis methods. However, these materials, when synthesized using typical methods, may undergo significant phase transitions and lattice distortions, particularly when cycled at high voltages, resulting in rapid capacity degradation. Molten salt methodologies have been used with NaOH as the salt source. These methods may include multiple heating and cooling stages during the calcination process owing to the initial melting of NaOH.

The advancement of large-scale electrochemical energy storage systems has attracted considerable attention in recent years, driven by the growing demand for green and sustainable energy technologies. Among the emerging technologies, sodium-ion batteries (SIBs) have experienced a resurgence of interest as a viable alternative to lithium-ion batteries (LIBs), attributed to their cost-effectiveness, utilization of more abundant and noncritical minerals, and the widespread availability of sodium resources. Similar to the positive electrode materials in LIBs, the positive electrode plays a crucial role in determining the overall SIB performance, including capacity, operating voltage, cycle life, and energy density. Among the numerous reported positive electrodes in SIBs, P2-type Na_{0.67}Ni_{0.33}Mn_{0.67}O₂ (NNMO) has garnered widespread attention for its exceptional electrochemical performance. Notably, it exhibits structural stability under ambient conditions, a high average operating voltage, and a theoretical capacity of approximately 173 mAh g⁻¹, resulting in the high energy density among layered transition metal oxides when employed in full cell configurations. However, when NNMO is charged to approximately 4.2 V vs. Na/Na⁺, the removal of Na⁺ led to layer glide which induces the P2-O2 phase transition, resulting in rapid capacity degradation. In light of the aforementioned challenges affecting the material's cycling stability, optimization strategies have been implemented, including element substitution or doping and surface modification.

The synthesis of NNMO has predominantly yielded polycrystalline secondary particles formed through traditional coprecipitation and calcination methods to date. Interests in obtaining single-crystal materials as a promising alternative to polycrystalline materials has grown in recent years, aiming to address capacity degradation via prioritizing the mitigation of intergranular particle cracking. Various methods have been used for synthesizing single-crystal particles; among them, the molten salt method is especially compelling for its capability to facilitate the dissolution and subsequent recrystallization of active materials during the synthesis process.

The molten salt synthesis utilizes molten salt as a reaction medium for constituent precursors, enabling molecular-scale mixing of reactants and yielding a homogeneous and structurally uniform final product. It is widely regarded as one of the simplest and most cost-effective strategies for fabricating positive electrode materials for LIB systems. Despite the similarity in SIB and LIB systems, reports on the synthesis of positive electrode materials using molten salt methods in SIBs remain scarce.

Other disadvantages, drawbacks, inefficiencies, and issues may also exist.

### SUMMARY

Accordingly, disclosed embodiments address the above, and other, disadvantages, drawbacks, inefficiencies, and issues with existing systems, materials, and methods.

Disclosed embodiments include a method for the synthesis of a layered transition metal oxide cathode material that overcomes at least one of the shortcomings described above.

In an embodiment, a method for synthesizing a layered transition metal oxide material includes grinding a salt, a first transition metal oxide, a second transition metal oxide, and an alkali metal carbonate together to form a mixture. The salt may be sodium chloride (NaCl). The method further includes calcining the mixture to form a calcined mixture. The method also includes cooling the calcined mixture to room temperature. The method includes washing the calcined mixture with deionized water. The method further includes adding Na₂CO₃ to the calcined mixture. The method also includes grinding the calcined mixture. The method includes reheating and re-cooling the calcined mixture to form a layered transition metal oxide material.

Also disclosed is a material and synthesis process that overcomes at least one of the shortcomings described above. In an embodiment, Fe_{0.2}Mn_{0.8}(OH)₂ materials are synthesized using potassium oxalate as a chelating agent in synthesizing dense, spherical ahydroxide particles.

Also disclose herein are the morphological and structural characteristics and electrochemical performance of single crystalline P2-type NNMO (SC-NNMO) positive electrode material synthesized using a straightforward NaCl-based molten salt method. In some embodiments Na₂CO₃ is used as the Na source, and a simple continuous heating and natural cooling process is adopted to synthesize the single crystal material. Compared to polycrystalline NNMO (PC-NNMO) synthesized by the conventional calcination method, single crystalline NNMO with a plate-like morphology may be made which exhibited an initial capacity of 90.6 mAh g⁻¹ at 0.1 C between 2.0 and 4.2 V, with a retention of 88.5% after 100 cycles. The material demonstrated long-term stability, retaining 83.9% of its initial capacity after 300 cycles at 1 C. In a SC-NNMO//hard carbon full cell, it still retained 90.3% of its initial capacity after 200 cycles at 1 C. Disclosed embodiments establish molten salt synthesis as a facile, scalable, and efficient approach for producing high-performance single-crystal positive electrode materials for sodium-ion batteries.

Other advantages, efficiencies, and benefits also exist.

### BRIEF DESCRIPTION OF THE DRAWINGS

FIGS. 1A-1B is Rietveld refinements of XRD patterns of (A) SC-NNMO and (B) PC-NNMO, respectively.

FIG. 1C is a SEM image of SC-NNMO.

FIGS. 1D-1G are, respectively, a TEM image of SCNNMO, a high-magnification TEM image, a HRTEM image of SC-NNMO along the (012) zone axis, and selected area electron diffraction (SAED) pattern of the pristine SC-NNMO sample.

FIGS. 1H-1L are high-angle annular dark-field (HAADF) image and corresponding EDS mappings of SC-NNMO.

FIGS. 2A-2B are voltage profiles of SC-NNMO and PC-NNMO, respectively, at 0.1 C rate at different cycles (1 C corresponds to 150 mA g⁻¹).

FIG. 2C is rate capability with standard deviation for SC-NNMO and PC-NNMO.

FIGS. 2D-2E are cycle life at 0.1 C rate and 1 C rate, respectively.

FIGS. 3A-3B are cyclic voltammograms of SC-NNMO and PC-NNMO positive electrode materials, respectively, at different scan rates.

FIGS. 3C-3D are the voltametric response for SC-NNMO and PC-NNMO, respectively, at 0.1 mV s⁻¹. The dotted shaded area is the capacitive contribution.

FIG. 4A is a schematic diagram of Na ion full batteries with SC-NNMO and hard carbon electrode material.

FIGS. 4B-4C show voltage profiles and CV curves, respectively, of SC-NNMO positive electrode material and hard carbon negative electrode materials.

FIG. 4D shows cycling performance at 1 C (based on the active mass positive electrode).

FIGS. 4E-4F show voltage profiles and rate capabilities, respectively, of the full battery at 1.9-4.1 V.

FIG. 5 is a flowchart depicting an embodiment of a method for synthesizing a layered transition metal oxide material.

FIGS. 6A-6B are SEM images of pristine SC-NNMO powders: (A) low magnification and (B) high magnification, respectively.

FIGS. 7A-7B are SEM images of pristine PC-NNMO powders: (A) low magnification and (B) high magnification, respectively.

FIGS. 8A-8B are CV curves with three cycles at 0.1 mV s⁻¹ of SC-NNMO and PC-NNMO, respectively.

FIGS. 9A-9B are EIS results of SC-NNMO and PC-NNMO pristine electrode materials and after 10^{th} cycle, respectively.

FIG. 9C is the relationship between Zᵣₑ and ω^{-1/2} at low frequency of SC-NNMO (squares, solid line) and PC-NNMO (circles, dashed line) and their corresponding Na⁺ diffusion coefficient, respectively.

FIGS. 10A-10C are ex-situ XRD results of SC-NNMO, PC-NNMO at different states of charged, and both electrodes charged at 4.2V, respectively.

FIGS. 11A-11B are XRD results of SC-NNMO, PC-NNMO before and after 200 cycles at 0.1 C. A+indicates a Kapton tape peak and a * indicates and Al substrate peak.

FIGS. 12A-12D are SEM results of SC-NNMO ((A) pristine and (B) after 200 cycles at 0.1 C), and PC-NNMO ((C) pristine and (D) after 200 cycles at 0.1 C). The insets in each figure are high magnification images.

FIG. 13 is a galvanostatic charge/discharge profiles of hard carbon.

FIG. 14 is a Ragone plot for coin-type full cell.

FIGS. 15A-15D are a set of SEM images of hydroxide Fe_{0.2}Mn_{0.8}(OH)₂ precursors, formed with different chelation agents.

FIGS. 16A-16D are a set of SEM images of oxide Na_{0.67}Fe_{0.2}Mn_{0.8}O₂ (FM14) samples, formed with different chelation agents.

FIG. 17 is a box chart with normal distribution curves for FM14OH—OXA and the three FM14 oxides.

FIGS. 18A-18C are a set of graphs depicting refined X-ray diffraction patterns of FM14-OXA, FM14-NH3, and FM14-NOC (oxalate chelate: FM14-OXA; ammonia chelate: FM14-NH3; no chelate: FM14-NOC).

FIGS. 19A-19D area set of graphs depicting: (A) The cycle performance of the three FM14 materials at a current density of 175 mA/g in the voltage range of 2-4 V, and their resulting (B) average discharge voltage, (C) discharge energy, and (D) average voltage polarization.

FIGS. 20A-20B are a set of graphs depicting: (A) the rate performances of the FM14 samples under varying current densities, and (B) the charge and discharge curves of FM14-OXA under varying current densities.

FIG. 21 is a graph depicting a galvanostatic interruption titration technique (GITT) of the three oxide materials, aligned with their corresponding voltage profile.

FIG. 22 is the refined XRD pattern of the single crystal Na_{0.67}Fe_{0.2}Mn_{0.8}O₂ made by molten salt method.

FIGS. 23A-23B are SEM images of the as-prepared Na_{0.67}Fe_{0.2}Mn_{0.8}O₂ made by molten salt method.

FIGS. 24A-24G are TEM and EDS images of as-prepared Na_{0.67}Fe_{0.2}Mn_{0.8}O₂ made by molten salt method. Lattice fringes with the interlayer spacing of 5.6 Å are indexed to the (002) plane. EDS images show uniform distribution of Ni, Mn, and O among the sample.

FIG. 25 is comparison of the voltage profiles of the polycrystalline (PC) and the single crystal (SC) electrodes.

FIG. 26 is the differential capacity over voltage (dQ/dV) curves of PC-FM14 and SC-FM14 electrodes.

FIG. 27 is the differential capacity over voltage (dQ/dV) curves of PC-FM14 and SC-FM14 electrodes.

FIG. 28 is cycling performance of PC-FM14 and SC-FM14 electrodes.

FIG. 29 is the Na⁺ diffusion coefficients of PC-FM14 and SC-FM14 electrodes during charge.

FIG. 30 is the Na⁺ diffusion coefficients of PC-FM14 and SC-FM14 electrodes during discharge.

FIG. 31 is Galvanostatic Interruption Titration Technique analysis of PC-FM14 and SC-FM14 electrodes.

FIG. 32 is the electrochemical impedance spectroscopy of pristine PC-FM14 and SC-FM14 electrodes.

FIG. 33 is the electrochemical impedance spectroscopy of cycled PC-FM14 and SC-FM14 electrodes.

FIG. 34 is a HAADF-STEM imaging of FM14-OXA and EDX maps of different elements.

FIGS. 35A-35B are SEM images of the larger (A) FM14-NH3 and (B) FM14-NOC particles.

FIG. 36 is a pore size distribution (PSD) of the three pristine oxide samples, as determined by BET.

FIGS. 37A-37D are galvanostatic voltage profiles during the first 50 cycles at 175 mAh g⁻¹ with EIS spectra gathered at 2 V for several cycles for the (A) FM14-NH3, (B) FM14-NOC, (C) FM14-OXA, and (D) is electrochemical impedance spectroscopy. Boxes are experimentally collected data, lines are calculated spectra. Equivalent circuit model is provided in (B) as inset where R represents resistor, CPE as constant phase element and Z as the Warburg impedance element, respectively.

FIGS. 38A-38B are zoomed in EIS spectra for FM14-NH3, FM14-NOC, and FM14-OXA. Each sample's corresponding legend is below the figure. Boxes are experimentally collected data, lines are calculated spectra.

FIGS. 39A-39C are (A) the FM14 samples' cycling stability over 300 cycles at 175 mAh g⁻¹, (B) Static leakage current measurements for FM14-OXA and FM14-NH3 at several voltage points between 2.8 and 4 V. The error band represents the standard deviation between multiple cells of that material. FIG. 39 (C) is the average voltage polarization of the cells during long cycling at 175 mA g⁻¹.

FIGS. 40A-40B are (A) the rate performances of the FM14 samples under varying current densities and (B) GITT of the three oxide materials, aligned with their corresponding voltage profile.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

One disclosed method may include synthesizing an iron-manganese-based hydroxide precursor for a sodium-ion layered transition metal oxide. During the synthesis of the iron-manganese-based hydroxide precursor, potassium oxalate may be used as a chelating agent. For example, the iron-manganese-based hydroxide precursor may be Fe_{0.2}Mn_{0.8}(OH)₂ and the potassium oxalate is K₂C₂O₄.

Synthesizing the iron-manganese-based hydroxide precursor may include forming a 1-mole-per-liter manganese sulfate (MnSO₄·H₂O), iron sulfate (FeSO₄·7H₂O), water solution. Forming the manganese sulfate, iron sulfate, water solution may include combining MnSO₄·H₂O and FeSO₄·7H₂O in a stoichiometric 1:4 molar ratio in an argon purged volumetric flask. Forming the solution may further include purging nanopure water with argon gas for 30 minutes to form de-aerated water. Forming the solution may also include pumping the de-aerated water into the flask. Finally, forming the solution may include dissolving the MnSO₄·H₂O and FeSO₄·7H₂O into the de-aerated water.

Next, synthesizing the iron-manganese-based hydroxide precursor may include adding the 1-mole-per-liter manganese sulfate, iron sulfate, water solution to a 0.5-mole-per-liter oxalate, water solution at a constant rate to form a precursor solution. The constant flow rate may be 0.1 grams per minute. A constant molarity of 0.5-mole-per-liter of potassium oxalate within the precursor solution may be maintained by adding a 0.75-mole-per-liter potassium oxalate, water solution to the precursor solution. Likewise, a constant pH of 10.5 within the precursor solution may be maintained by adding a 0.75-mole-per-liter potassium oxalate, water solution to the precursor solution.

Forming the precursor solution may be performed within a reactor vessel. The contents of the reactor vessel may be kept under constant argon flow and kept at a temperature of 60 degrees Celsius for a residence time of 10 hours.

Synthesizing the iron-manganese-based hydroxide precursor may further include filtering the precursor solution, mixing the precursor solution for 10 hours, rinsing the precursor solution with 3 L of 30-minute-argon-purged nanopure water, drying the rinsed precursor solution in an ambient oven at 100 degrees Celsius for approximately 1 hour, and transferring the precursor solution to a vacuum oven at 70 degrees Celsius to dry for at least 8 hours to form the precursor. The solution may then be passed through a 150-micrometer sieve. The precursor may then be stored in an argon-filled glovebox to avoid oxidation.

Embodiments of the method may further include mixing the precursor with Na₂CO₃ in a mortar and pestle for 15 minutes to form mixed powders of the precursor and the Na₂CO₃. The method may include calcining the mixed powders at 900 degrees Celsius for 15 hours with a heating rate of 3 degrees Celsius per minute followed by immediate 900 degrees Celsius quenching on aluminum foil to form a layered transition metal oxide. A resulting layered transition metal oxide may be Na_{0.67}Fe_{0.2}Mn_{0.8}O₂.

SC-NNMO and PC-NNMO were synthesized via the molten salt and conventional coprecipitation-calcination method, respectively. The conventional coprecipitation-calcination synthesis method was adopted know techniques. The molten salt method is briefly described as follows: Anhydrous ethanol served as the dispersant. NaCl was used as the molten salt flux. NiO or Fe₂O₃, Mn₂O₃, Na₂CO₃, and NaCl were uniformly hand-ground for 20 min in an agate mortar in a molar ratio of 1:1:1.05:2, with ethanol. The extra Na₂CO₃ (5%) was used to account for the loss during high temperature calcination. The mixed powders were then calcined in a furnace at 1000 °C for 15 h under air, followed by natural cooling to room temperature. The final product was then transferred to a glovebox to prevent air exposure.

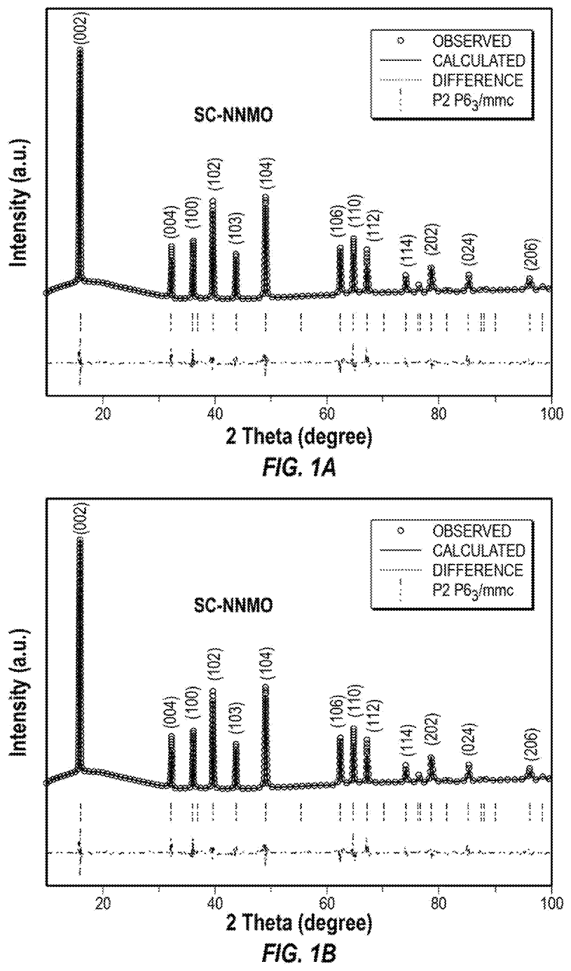

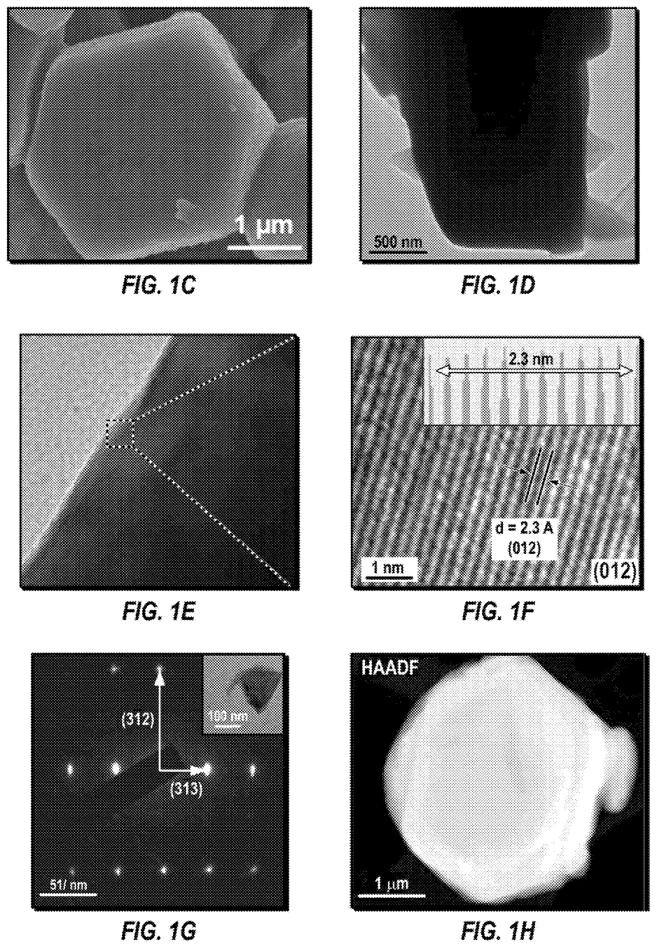

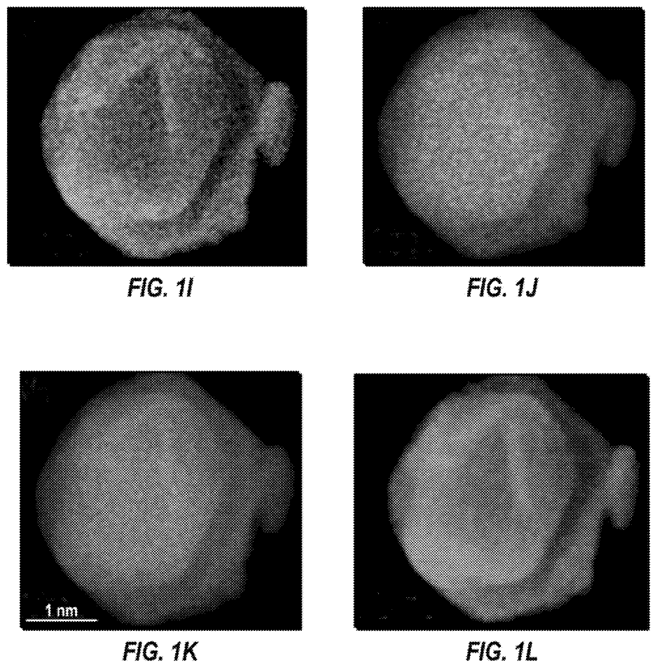

The crystal structure of as-synthesized samples was characterized by X-ray diffraction (XRD) and is shown in FIGS. 1a and 1b. No impurities or secondary phases were observed in these two samples. SC-NNMO showed highly intense and sharp peaks, while PC-NNMO showed less intense and broader diffraction peaks. Both samples displayed well-indexed diffraction patterns consistent with the NaₓCoO₂-type P2 structure (space group: P6₃/mmc), as determined by Rietveld refinement, and the refined results are presented in Tables I and II below. The atomic ratios of Na, Ni, and Mn in the as-prepared samples were determined via inductively coupled plasma mass spectrometry (ICP-MS) measurement and found to be 0.65, 0.34, and 0.66 for SC-NNMO and 0.68, 0.33, and 0.67 for PC-NNMO as shown in Table III below, closely aligning with the target composition of Na, Ni, and Mn, except for the slightly lower Na content in SC-NNMO. The reduction in Na content of SC-NNMO was due to the sodium loss/evaporation during the high temperature calcination process.

TABLE I
Lattice parameter of SC-NNMO by XRD Rietveld refinement

| Atom | Site | x | y | z | Occ. | Uiso. |
|---|---|---|---|---|---|---|
| Na_{f} | 2b | 0.0000 | 0.0000 | 0.2500 | 0.266(3) | 0.057 (2) |
| Naₑ | 2d | 0.3333 | 0.6667 | 0.7500 | 0.404 (3) | 0.057 (2) |
| Ni | 2a | 0.0000 | 0.0000 | 0.0000 | 0.330 | 0.016 (1) |
| Mn | 2a | 0.0000 | 0.0000 | 0.0000 | 0.670 | .0016 (1) |
| O | 4f | 0.3333 | 0.6667 | 0.0828 (2) | 1.000 | 0.013 (1) |

a = b = 2.8807 (1) Å;
c = 11.1497 (2) Å;
volume = 80.127 (2) Å³;
R_{wp} = 3.50%;
χ² = 1.81

TABLE II
Lattice parameter of PC-NNMO by XRD Rietveld refinement

| Atom | Site | x | y | z | Occ. | Uiso. |
|---|---|---|---|---|---|---|
| Na_{f} | 2b | 0.0000 | 0.0000 | 0.2500 | 0.256(3) | 0.109 (2) |
| Naₑ | 2d | 0.3333 | 0.6667 | 0.7500 | 0.414 (3) | 0.109 (2) |
| Ni | 2a | 0.0000 | 0.0000 | 0.0000 | 0.330 | 0.045 (1) |
| Mn | 2a | 0.0000 | 0.0000 | 0.0000 | 0.670 | .0045 (1) |
| O | 4f | 0.3333 | 0.6667 | 0.0817 (3) | 1.000 | 0.046 (1) |

a = b = 2.8860 (1) Å;
c = 11.1502 (2) Å;
volume = 80.429 (5) Å³;
R_{wp} = 3.29%;
χ² = 1.69

TABLE III
ICP-MS results of SC-NNMO and PC-NNMO electrode materials

| Materials | Na/TMs | Ni/TMs | Mn/TMs |
|---|---|---|---|
| SC-NNMO | 65.26% | 33.86% | 66.14% |
| PC-NNMO | 68.31% | 33.28% | 66.72% |

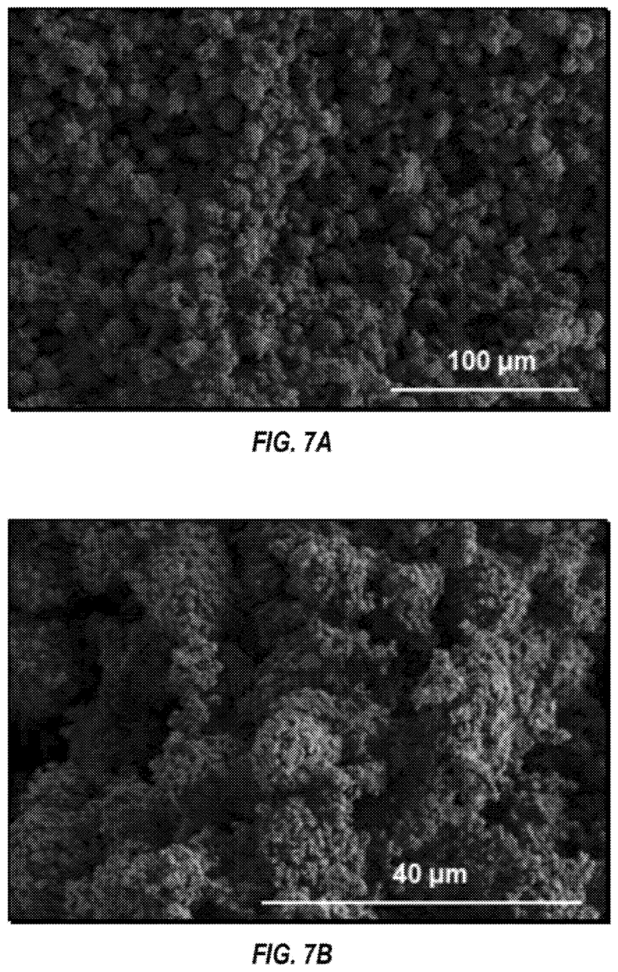

The morphologies of SC-NNMO and PC-NNMO samples were investigated using a scanning electron microscope (SEM), shown in FIG. 6A-6B and FIG. 7A-7B. The SC-NNMO sample exhibits an average particle size of approximately 3 μm, demonstrating a plate-like morphology, while the PC-NNMO sample is composed of ~10 μm secondary particles with densely packed primary particles. The plate-like morphology of SC-NNMO is also shown in FIG. 1C. The microstructure of SC-NNMO particles was further examined by using high resolution transmission electron microscopy (HRTEM). The SC-NNMO material exhibited a single crystal structure, consistent with the XRD patterns (FIGS. 1D-1G). The interplanar spacing was determined to be 0.23 nm, corresponding to the (012) diffraction plane of the P2-type structure. Additionally, energy-dispersive X-ray spectroscopy (EDS) mappings in FIGS. 1H-1L verified that all elements were uniformly distributed.

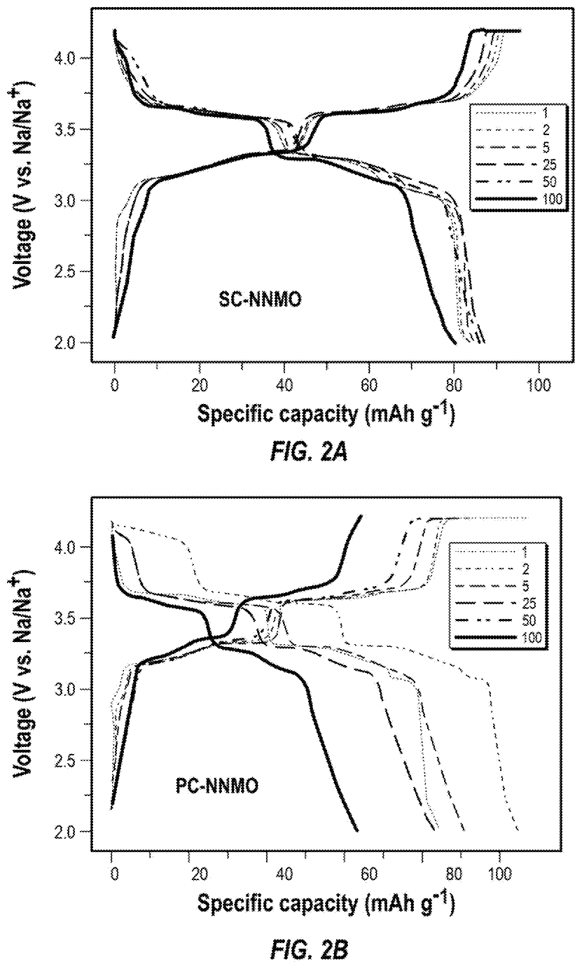

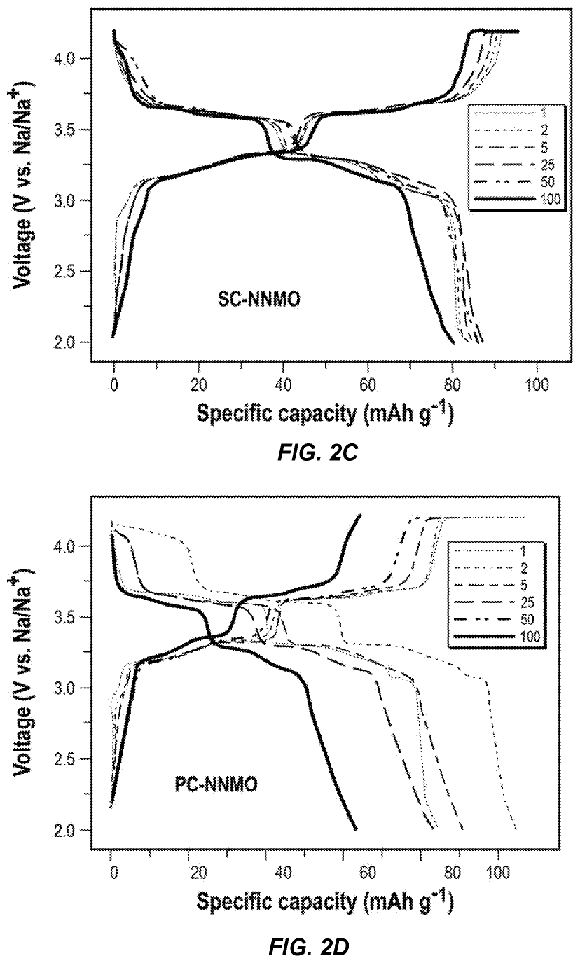

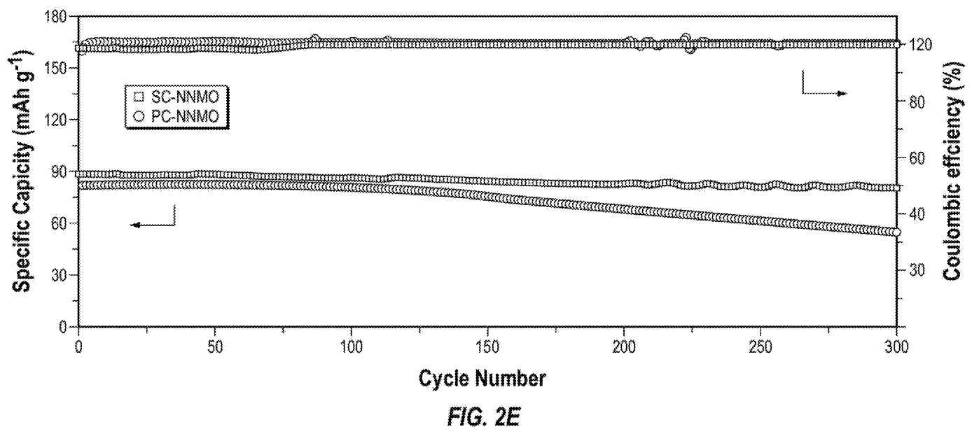

The electrochemical performances of SC-NNMO and PCNNMO electrode materials were evaluated in a Na half-cell configuration within 2.0-4.2 V vs. Na/Na⁺. FIGS. 2A and 2B show the voltage profiles of the two samples in different cycles. A series of plateaus at distinct voltage ranges were observed during the initial cycle, corresponding to various redox reactions and the rearrangement of Na⁺/vacancy ordering. When the SC-NNMO positive electrode material charged to the voltage around 4.2 V, the shorter voltage plateau (compared to PC-NNMO) demonstrated better stability at high voltage, owing to the suppression of P2-O2 phase transition. FIG. 2C compares the rate capabilities of the two samples, showing the SC-NNMO sample exhibiting superior performance. The average discharge capacities of SCNNMO were 84.4, 83.6, 82.3, 79.5, 78.8, 74.3, and 72.3 mAh g⁻¹ at 0.1 C, 0.2 C, 0.5 C, 1 C, 2 C, 5 C, and 10 C, respectively. The observed capacity of the PC-NNMO electrode increased in the first ten cycles, possibly due to the initial insufficient wetting of the electrode-electrolyte interface. Upon returning to 0.1 C from the 10 C rate, the capacity fully recovered, indicating rapid kinetics for the SC-NNMO positive electrode. However, the rate capacities of PC-NNMO displayed a faster decline with an increasing C rate. The cycling stability of the two samples at a low C rate (0.1 C) and a high C rate (1 C) is shown in FIGS. 2D-2E, respectively. The initial specific discharge capacity of SC-NNMO at 0.1 C was 90.6 mAh g⁻¹, with a capacity retention rate reaching 88.5% after 100 cycles, while the PC-NNMO was only 75.6%. Furthermore, at a high C rate (1 C), the capacity retention for SC-NNMO was 83.9% compared to 66.6% for PC-NNMO after 300 cycles, with an average Coulombic efficiency exceeding 95% (FIG. 2E). The excellent cycling performance of SC-NNMO suggested that NNMO synthesized via the molten salt method exhibited superior structural stability.

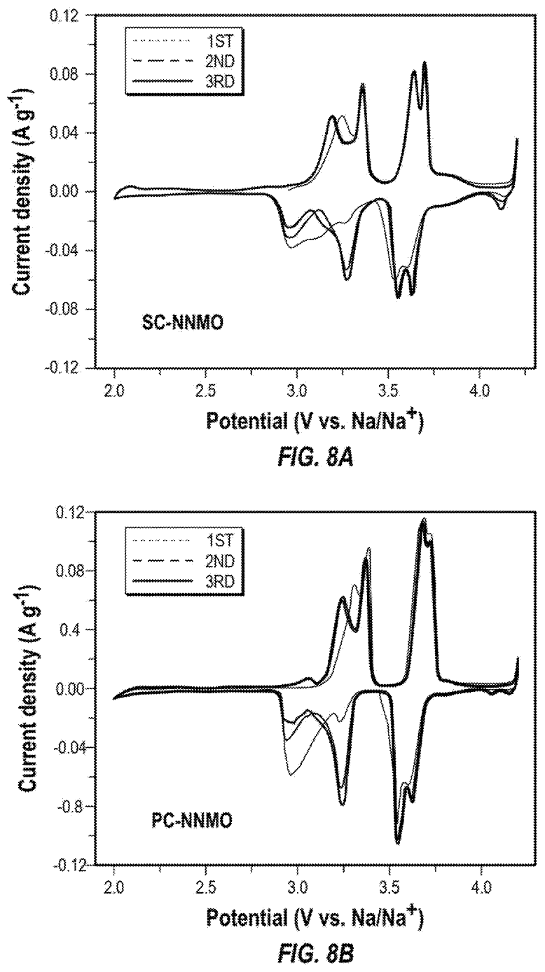

In order to understand the Na⁺ storage mechanism in the samples, a cyclic voltammetry (CV) measurement with varying scan rates was conducted. First, the CV curves of the SCNNMO sample at a scan rate of 0.1 mV s⁻¹ during the initial cycle (FIG. 8A) exhibited four redox peak pairs at 3.70/3.60 (~100 mV of peak separation), 3.65/3.54 (90 mV), 3.36/3.26 (100 mV), and 3.25/2.97 V (280 mV), respectively. These peak pairs correspond to the plateaus appearing in the initial cycle (FIG. 2A). Similarly, the PC-NNMO electrode material also showed four pairs of redox peaks as shown in FIG. 8B at 3.73/3.60 (130 mV), 3.69/3.54 (150 mV), 3.39/3.24 (150 mV), and 3.31/2.97 V (340 mV). Both samples displayed four distinctive redox peaks pairs, near ~3.1, 3.3, 3.6, and 3.7 V vs. Na/Na⁺ associated with Ni^{2+/3+/4+} redox, which was consistent with results reported in the literature and indicating these two samples had undergone similar redox reactions. The lower peak separation of the SC-NNMO sample suggested it has lower polarization and higher reversibility. Besides, the high degree of overlap between the second and the third cycles of SC-NNMO indicated a highly reversible Na insertion and extraction process. Thus, the SC-NNMO electrode material demonstrated superior reversibility compared to that of the PC-NNMO electrode material. Additionally, the little deviation observed in first three cycles may be associated with side reactions, such as surface interactions between the electrolyte and electrodes.

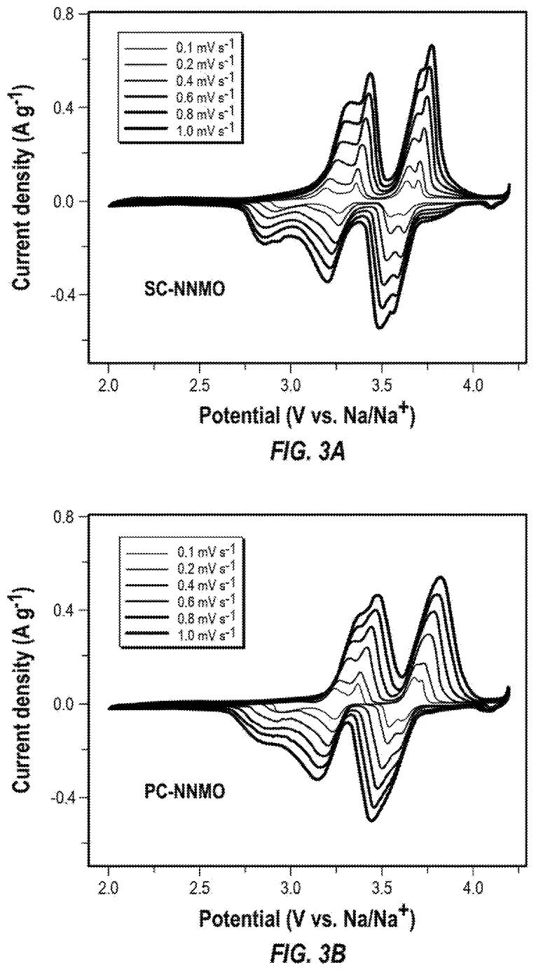

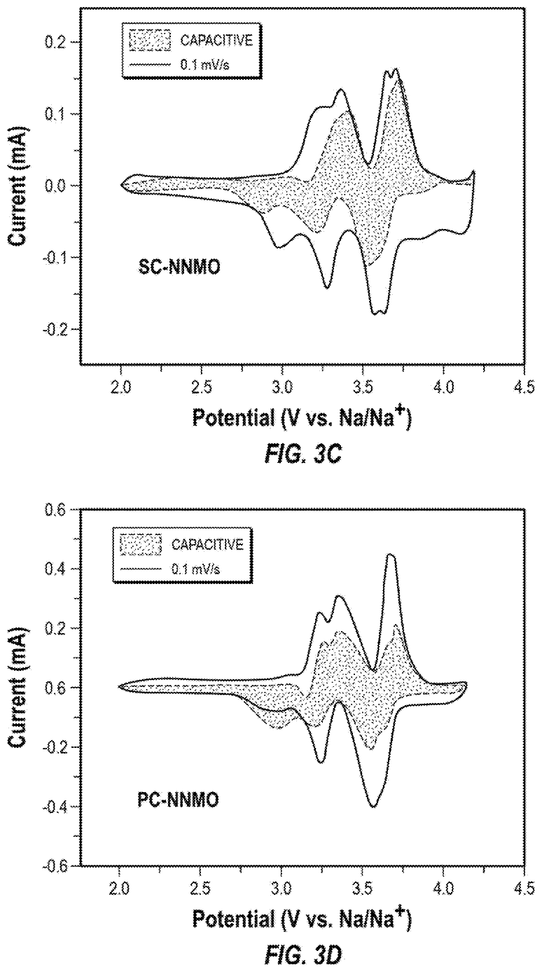

The CV curves of SC-NNMO and PC-NNMO samples at different scan rates are shown in FIGS. 3A-3B. The corresponding CV responses could be analyzed based on the analysis equation i(V)=k₁v+k₂v^{1/2}, where the terms k₁v and k₂v^{1/2} refer to the contributions from surface capacitive and diffusion-controlled intercalation, respectively. It was found that the capacitive contribution of the SC-NNMO sample (FIG. 3C) was 49.7%, a little lower than 57.5% of the PC-NNMO (FIG. 3D) at 0.1 mV s⁻¹, which is reasonable since SC-NNMO has a smaller surface area. This suggests that there is more diffusion contribution in the SC-NNMO sample than PC-NNMO.

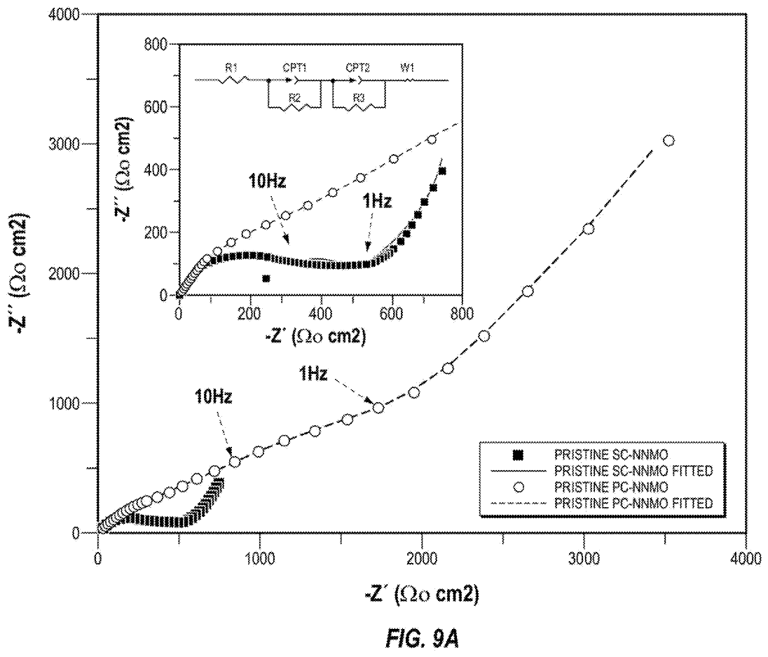

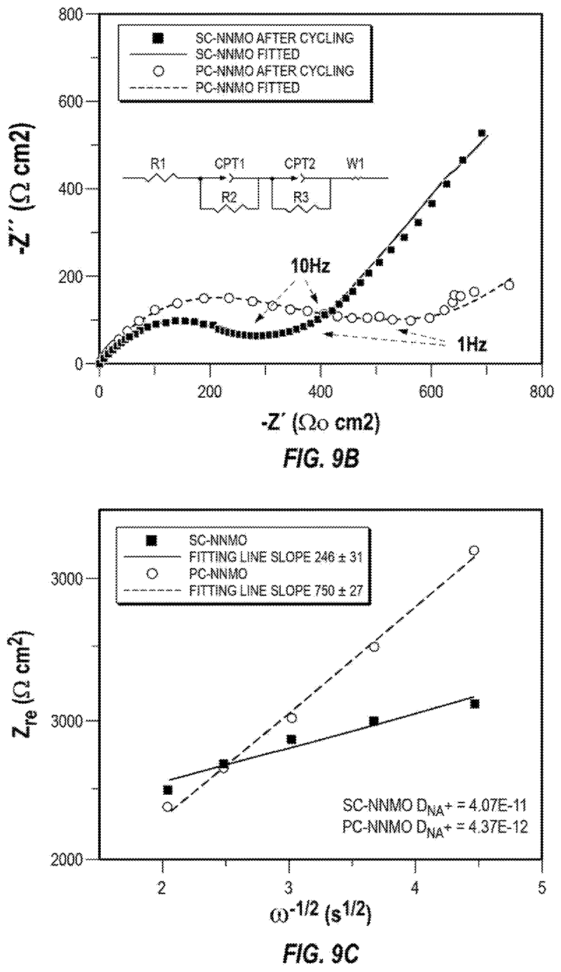

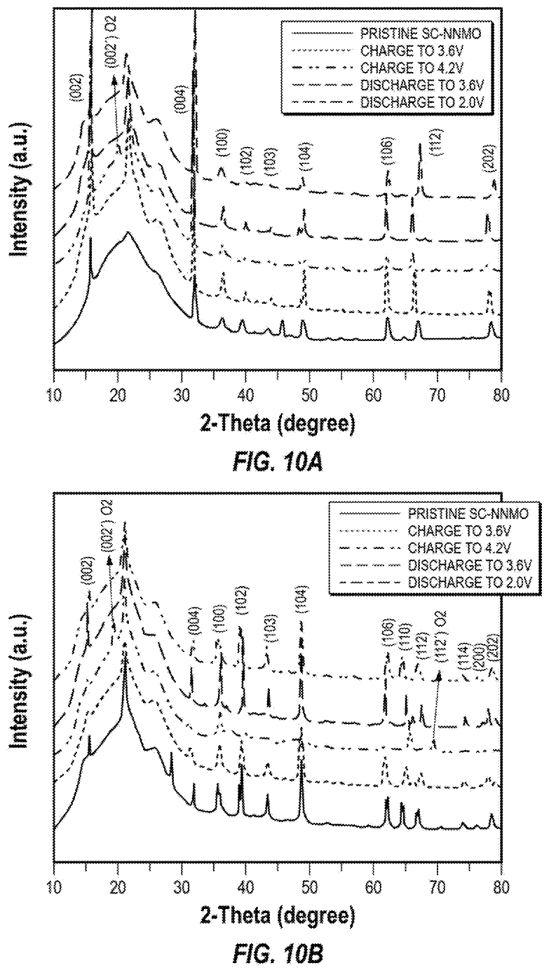

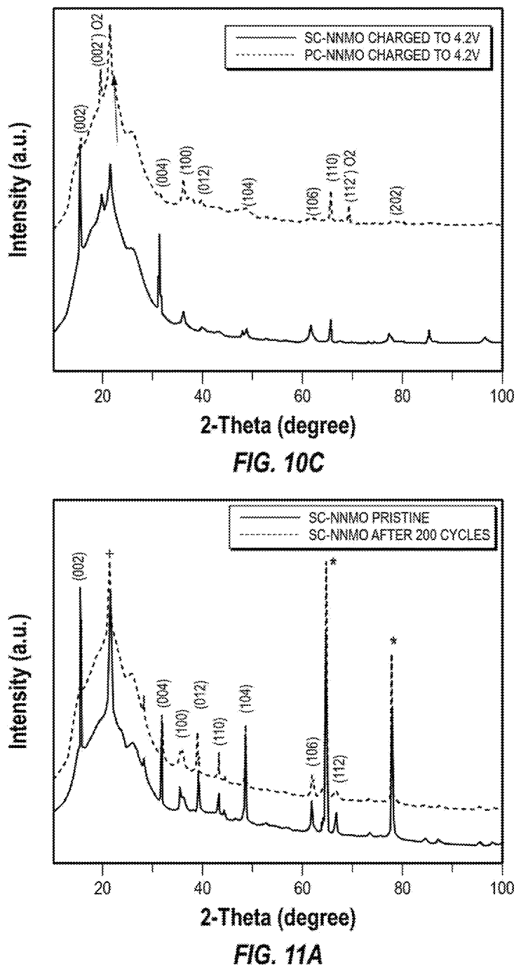

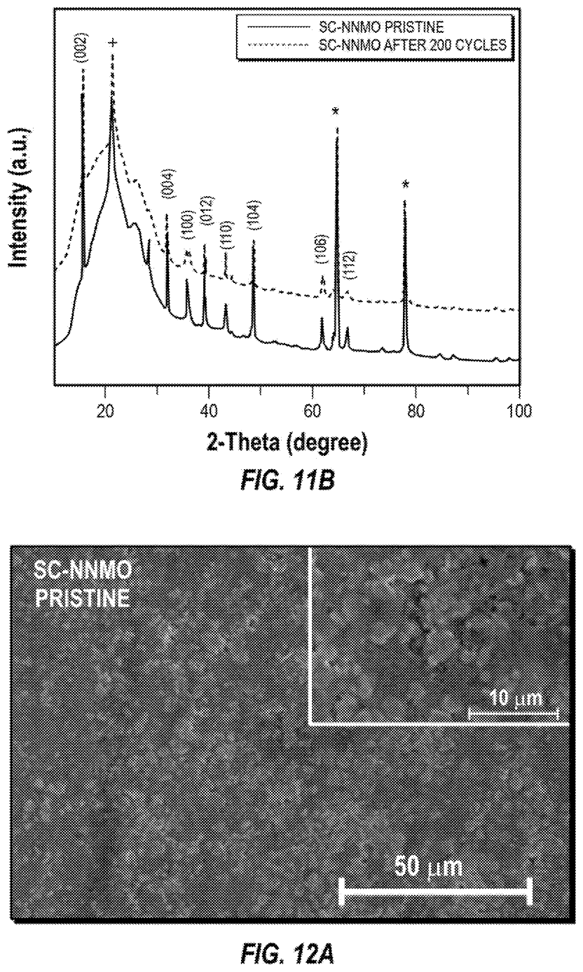

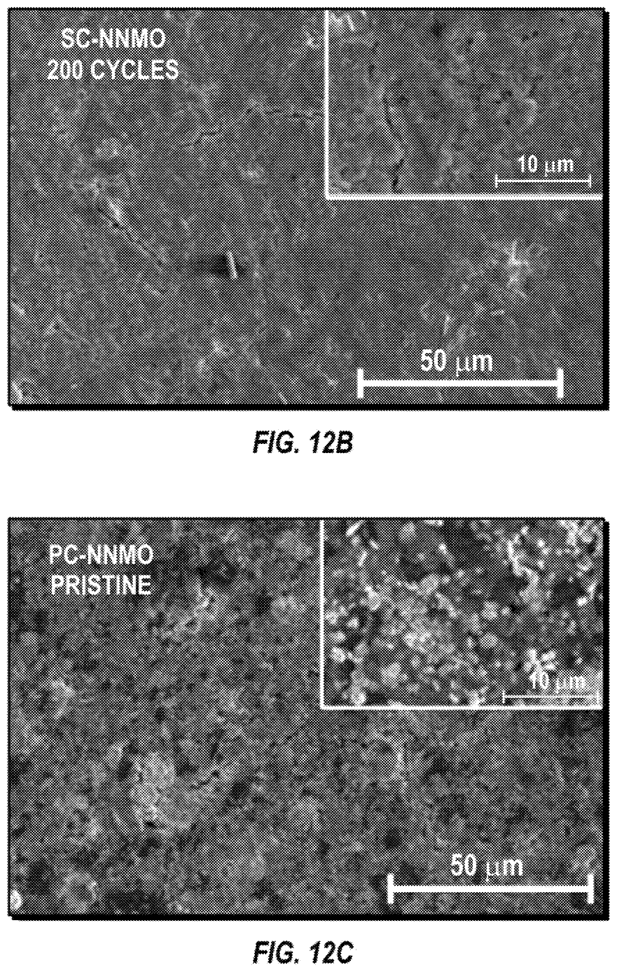

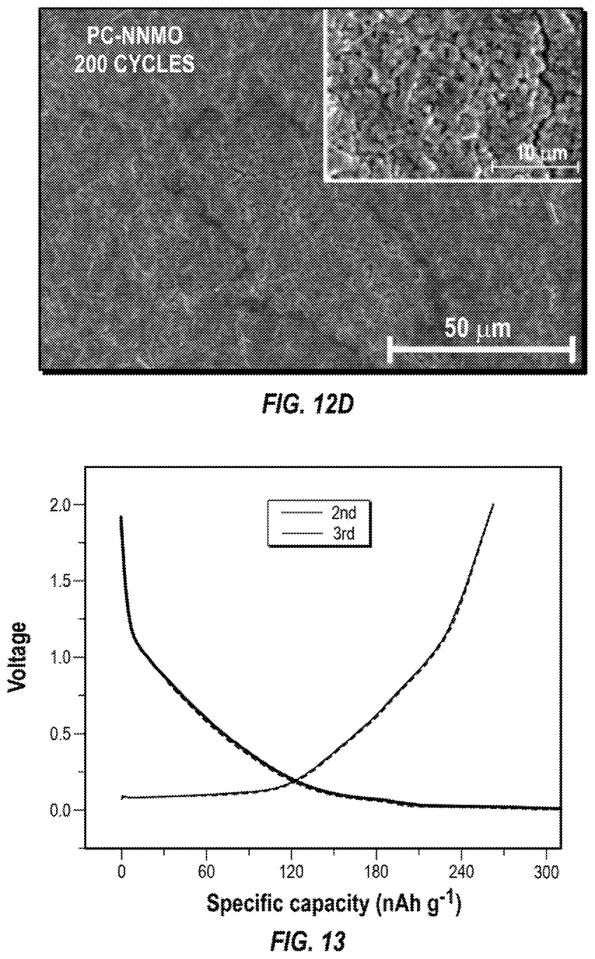

The electrochemical impedance spectroscopy (EIS) measurements for both samples were then conducted to investigate pristine and cycled samples' Na⁺ diffusion kinetics. The Nyquist plots and the corresponding equivalent circuit of pristine and cycled samples, employed to model the interfacial properties, are shown in FIG. 9A-9B. Both samples exhibited two semicircles in the intermediate frequency region and an oblique line in the low frequency region, which correspond to the ohmic resistance (RΩ) at the intercept, cathode electrolyte interphase resistance (R_{SEI}), charge transfer resistance (R_{ct}), and Warburg impedance (Z_{w}), respectively. The R_{ct} represents the Na⁺ charge transfer resistance at the interface between the electrode and the electrolyte, while Z_{w} is associated with Na⁺ diffusion within the bulk of the electrode materials. It was observed that the pristine PC-NNMO electrode material exhibited a higher R_{ct} (752.7Ω) value compared to pristine SC-NNMO (309.1Ω), indicating more grain boundaries for polycrystalline PC-NNMO might impede the charge transfer kinetics at the electrode/electrolyte interface. The EIS of both samples after the 10th cycle is shown in FIG. 9B. Both electrodes exhibited reduced impedance, which suggested activation of the electrodes during cycling. It was evidenced that SC-NNMO exhibited a lower R_{ct} (233.3Ω) compared to PC-NNMO (295.5Ω). The lower R_{ct} in the SC-NNMO electrode material can be attributed to its superior structural stability by suppressing the P2-O2 phase transition around 4.2 V (ex situ XRD, FIGS. 10A-10C), which also agrees with the shorter plateau in FIG. 2B. Meanwhile, the crystal structures and morphologies of SC-NNMO and PCNNMO samples cycled after 200 cycles at 0.1 C were examined. XRD results (FIGS. 11A-11B) suggest that both samples maintained the P2 structure. On the other hand, the cycled PC-NNMO electrode exhibited a large number of cracks as compared to the SC-NNMO electrode (FIGS. 12A-12D), which indicates the improved mechanical properties of the SCNNMO material. In addition, the Na⁺ diffusion coefficients for SC-NNMO and PC-NNMO can be calculated through EIS as described below and with reference to FIG. 9C and were 4.07×10⁻¹¹ and 4.37×10⁻¹² m s⁻¹, respectively. The one magnitude higher value of the Na⁺ diffusion coefficient indicated the faster kinetic behavior of SC-NNMO than the PC-NNMO sample, which corroborates well with the rate performance.

The Na⁺ diffusion coefficients for SC-NNMO and PC-NNMO can be calculated through EIS data based on the following equation:

$${D}_{N {a}^{+}} = 0.5 {( \frac{R T}{A c {F}^{2} {σ}_{ω}} )}^{2}$$

Where D_{Na+} represents the diffusion coefficient of Na⁺ in positive electrode material, R is the molar gas constant, T is the temperature in Kelvin, A is the surface area of the electrode, F is the Faraday's constant, σ_{ω} is the slope of the functional relationship between Zᵣₑ and ω^{-1/2}, and C is the molar concentration of Na⁺ in the positive electrode material.

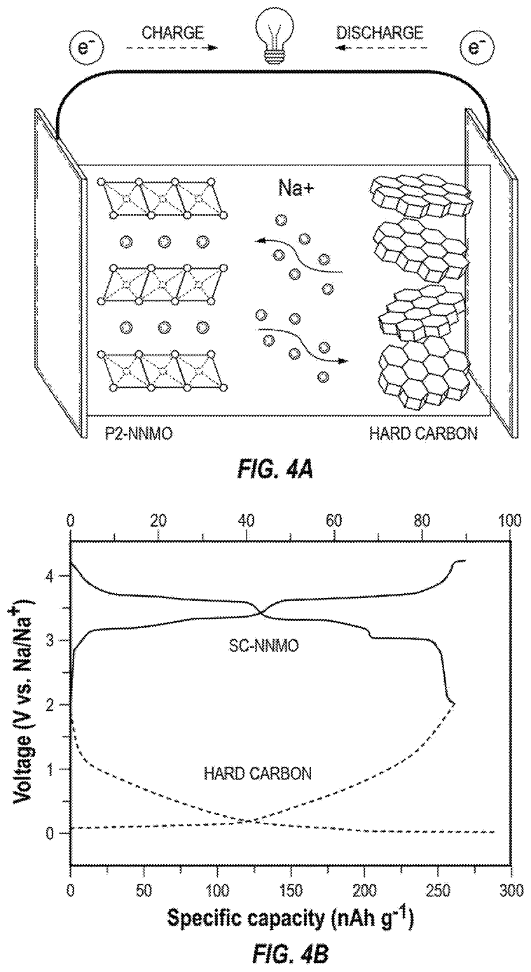

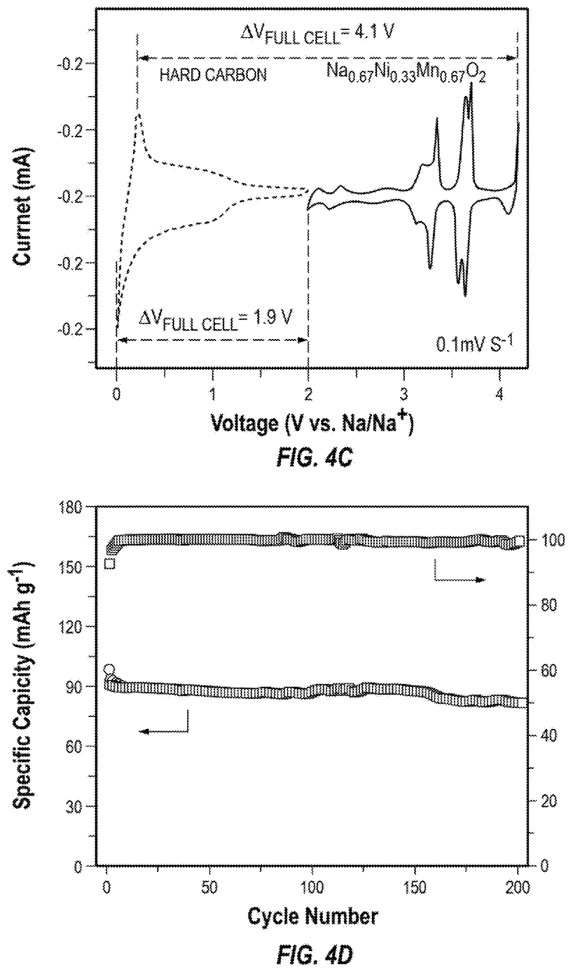

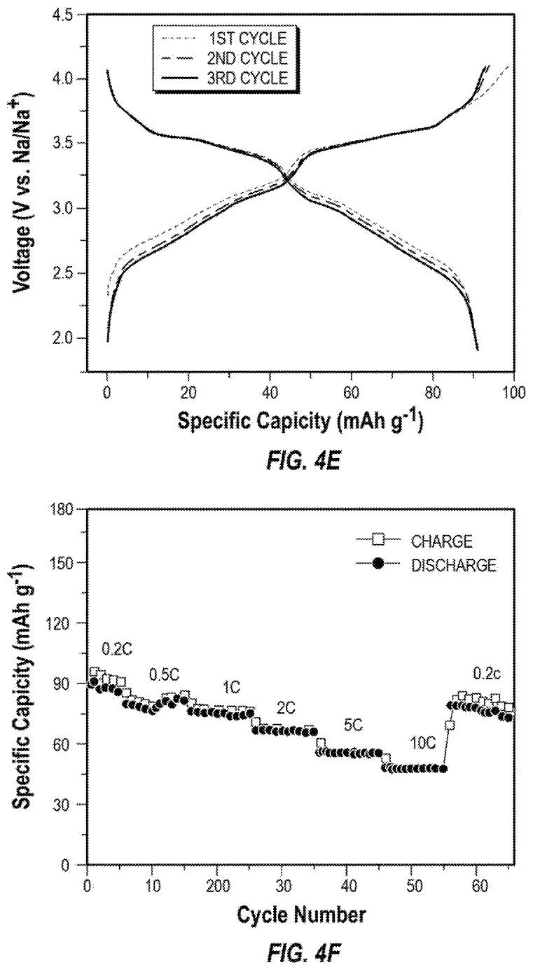

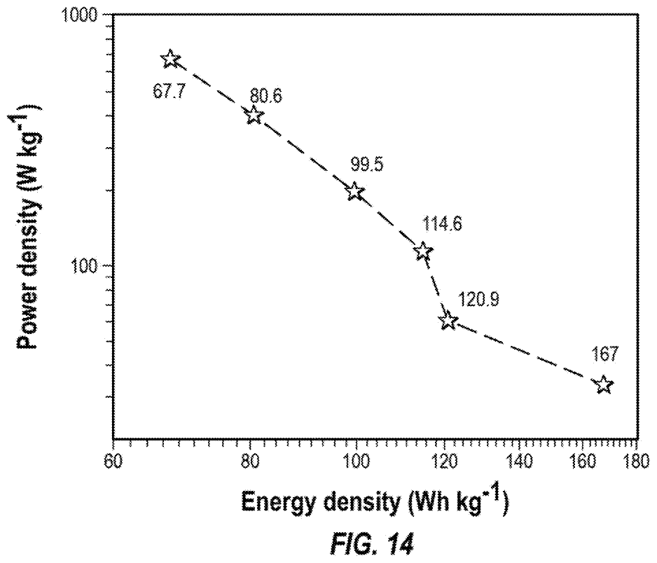

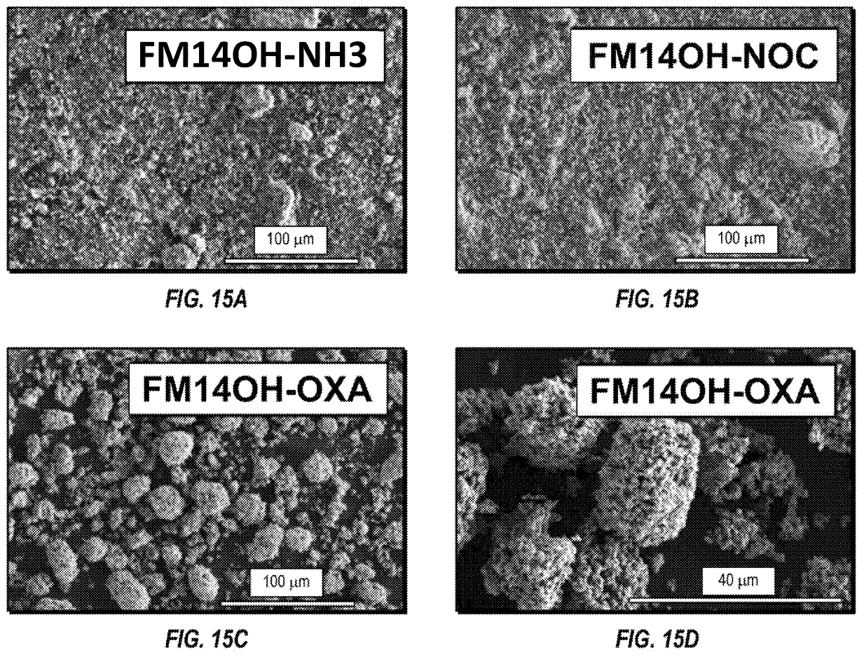

A full cell featuring the SC-NNMO positive and commercial hard carbon (HC) negative electrode material (denoted as SCNNMO//HC) was assembled into a coin-type battery. Prior to assembling the full cell, the HC negative electrode was precycled in a half cell at 0.1 C for three cycles to enhance its initial Coulombic efficiency (FIG. 13). The reaction mechanism of the charge-discharge process is schematically illustrated in FIG. 4A. During the charging process, Na⁺ was extracted from the SC-NNMO side and inserted into the HC side, while electrons migrated through the external circuit to the negative electrode material and vice versa. FIG. 4B-4C show the voltage profiles and CV curves of SC-NNMO and HC. FIG. 4E presents the galvanostatic charge-discharge curves of the coin-type full cell battery, demonstrating a specific capacity of approximately 100 mAh g⁻¹ based on the positive electrode material mass at 1.9-4.1 V. FIG. 4F illustrates the electrochemical performance of the SCNNMO//HC coin-type full cell at various current densities, delivering specific capacities of 112.2, 81.2, 77.4, 68.3, 56.9, and 49.1 mAh g⁻¹ at discharge rates of 0.2 0.5, 1, 2, 5, and 10 C, respectively. A Ragone plot based on the total mass of both positive and negative materials is presented in FIG. 14 to compare the power density vs energy density. Cycling performance in the full cell was a critical indicator for commercialization; thus, the cycling stability of the SCNNMO//HC coin-type full cell was evaluated following the rate capability test, as shown in FIG. 4D. This coin-type full cell exhibited a good capacity retention of 89.7% after 200 cycles at 1 C.

As shown, single crystalline Na_{0.67}Ni_{0.33}Mn_{0.67}O₂ positive electrode material with an average particle size of ~3 μm can be synthesized by a simple molten salt method. The composition, morphology, and structure were determined by ICP-MS, XRD, SEM, and TEM characterization. Compared to polycrystalline NNMO synthesized via the conventional coprecipitation-calcination method, SC-NNMO demonstrated superior structural stability and fast kinetics as indicated by excellent long cycling stability and rate capability in the wide voltage range of 2.0-4.2 V. The enhancement in cycling stability of the SC-NNMO sample can be explained by the suppressed P2-O2 phase transition at high voltage, which was further proven by ex situ XRD results. The Na⁺ charge storage and transport kinetics of the SC-NNMO and PC-NNMO electrode materials were evaluated by CV and EIS. It was found that the SC-NNMO sample has the higher capacity at a high C rate and good rate capability, which can be ascribed to its high Na⁺ diffusivity. Analysis of the capacitive and diffusion contribution in Na⁺ charge storage of the SC-NNMO sample suggests that there is more contribution from diffusion-limited intercalation for a single crystal structure than a polycrystalline structure. Moreover, inspired by the outstanding performance observed in half-cell testing, a full cell using the SC-NNMO and commercial HC electrode materials was assembled in a coin-type configuration. This full cell also exhibited an impressive capacity retention, demonstrating its significant practicality. This disclosure shows a new strategy in synthesizing high-performance layered oxide positive electrode materials via the molten salt method for sodium-ion batteries.

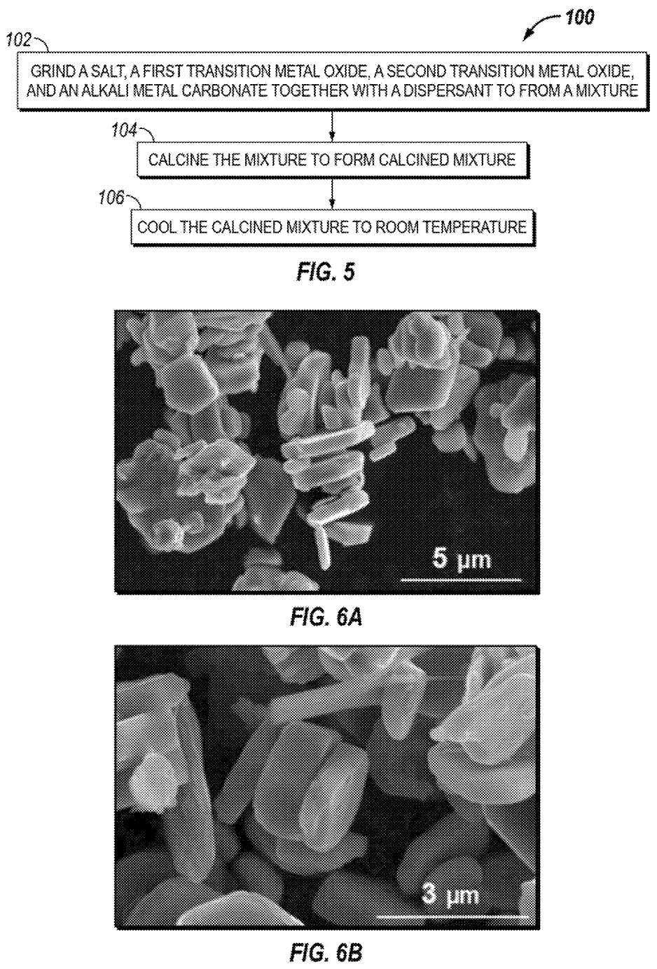

Referring to FIG. 5, an embodiment of a method 100 for synthesizing a layered transition metal oxide material is depicted. The method 100 may include grinding a salt, a first transition metal oxide, a second transition metal oxide, and an alkali metal carbonate together to form a mixture, at 102. The salt may be sodium chloride (NaCl). The first transition metal oxide may be nickel oxide (NiO). The second transition metal oxide may be manganese oxide (Mn2O3). The alkali metal carbonate may be sodium carbonate (Na2CO3). Grinding the salt, the first transition metal oxide, the second transition metal oxide, and the alkali metal carbonate together may include hand grinding for 20 minutes in an agate mortar in a molar ratio of 1:1:1.03 respectively. The alkali metal carbonate may include a 5 percent excess over the first transition metal oxide and the second transition metal oxide, to account for volatilization losses of a sodium source.

The method 100 may further include calcining the mixture to form a calcined mixture, at 104. Calcining the mixture may be performed in a furnace at 1000 °C for 15 hours under an air atmosphere. The method 100 may also include cooling the calcined mixture to room temperature, at 106, and washing the calcined mixture with deionized water, at 108.

The method 100 may further include adding more of the alkali metal bicarbonate to the calcined mixture, at 110. Adding more of the alkali metal carbonate may include adding 5% Na₂CO₃ to compensate for losses during the calcination process.

The method 100 may also include grinding the calcined mixture, at 112. Grinding the calcined mixture may include hand grinding for 20 minutes in an agate mortar.

The method 100 may include reheating and re-cooling the calcined mixture to form the layered transition metal oxide material, at 114. Reheating and re-cooling the calcined mixture may include heating to 750 °C for 10 hours in air and then cooling to room temperature. The layered transition metal oxide material may be transferred to a glovebox to prevent air exposure.

Disclosed embodiments also include material synthesis using three Fe_{0.2}Mn_{0.8}(OH)₂ (FM14OH) precursors materials, MnSO₄·H₂O and FeSO₄·7H₂O combined in a stoichiometric 1:4 molar ratio and placed in an argon purged volumetric flask. After purging nanopure water with argon gas for at least 30 minutes, the deaerated water was then pumped into a flask and the sulfate materials dissolved to make a 1 M solution, which was then kept under constant argon (Ar) flow. For the no-chelate precursor (FM14OH—NOC), the continuous stirred tank reactor (CSTR) was filled with nanopure water and a 1 M solution of NaOH was used to control pH. For the ammonia chelated precursor (FM14OH—NH3), continuous stirred tank reactor (CSTR) was filled with 1 M NH3 solution and a solution of 1 M NaOH/1.5 M NH₃ was used to control pH and maintain a constant NH₃ molarity of 1 M within the reaction vessel. For the oxalate chelated precursor (FM14OH-OXA), continuous stirred tank reactor (CSTR) was filled with 0.5 M K₂C₂O₄ solution and a solution of 1 M KOH/0.75 M K₂C₂O₄ was used to control pH and maintain a constant K₂C₂O₄ molarity of 0.5 M within the reaction vessel. For all three materials, the reactor vessel was maintained under constant Ar flow. The pH of the solution was closely monitored and held at a constant 10.5, while the transition metal flow was maintained at a flow rate of 0.1 g min⁻¹, the reactor was heated at a constant 60 °C, and the residence time was approximately 10 hours. After outputting the output material into waste for the first 12 hours, the output line was then connected to a filter under constant Ar flow. After running for approximately 72 hours more, the flow of transition metal sulfate was cut and the reaction vessel mixed for 10 more hours, after which the remaining solution was collected and rinsed with 3 L of 30-minute Ar purged nanopure water. The rinsed precursor was then dried in an ambient oven at 100 °C for approximately 1 hour and was then transferred to a vacuum oven at 70 °C to dry overnight. After drying the precursor material was then sieved through a 150 μm sieve and stored in an Ar filled glovebox to avoid oxidation.

The Fe_{0.2}Mn_{0.8}(OH)₂ precursors were thoroughly mixed with a designed mole ratio of Na₂CO₃ (5% molar excess) in a mortar and pestle for 15 minutes. The mixed powders were then calcined at 900 °C for 15 h with a heating rate of 3 °C/min. The calcined materials were then immediately quenched and quickly transferred to the glovebox to avoid exposure to moisture in the air. To clean off residual salts, the Na_{0.67}Fe_{0.2}Mn_{0.8}O₂ (FM14) samples were centrifuged with ethanol at 9000 rpm for 5 minutes, 3 times with agitation between each step. After this, the materials were then dried in a vacuum oven at 70 °C for 1-2 h and transferred back to the glovebox.

Materials Characterization. The crystal structures of the pristine materials were determined by XRD with a filtered Cu Kα (λ=1.5418 Å) source from 5 to 120° with a step of 0.01° and a scan rate of 3°/min. The XRD pattern was refined with the Rietveld method using the GSAS-II software. Scanning electron microscopy (SEM) was performed by using a Field Emission FEI FESEM system. Images were collected using the ETD detector with 0.20 nA current and an accelerating voltage of 5 kV. The tap density of the condensed powders was measured using a tap density tester. Approximately 25 cm³ of each powder sample was loaded into a graduated measuring cylinder under room temperature, which was mechanically tapped at a height of 3 mm and a frequency of 250 taps per minute. Volume readings were recorded after 5, 15, 30, 50, 100, 500, 1000, and 2000 taps. Using the measured mass and corresponding volume at each interval, the density was calculated. The tap density was determined as the value at which the powder volume stabilized and no further volume reduction was observed.

Electrochemical Characterizations. All laminated electrodes were prepared by screen printing a slurry of 80 wt % active material, 10 wt % C45 (Timcal), and 10 wt % poly(vinylidene fluoride) onto an aluminum foil current collector cleaned with ethanol by a compact tape casting coater, after which they were placed in an ambient oven at 60 °C for 1 hours before being transferred into a vacuum oven at 70 °C overnight. The dried laminate was then calendared with a ~20-30% reduction in laminate thickness, and 12.7 mm electrodes with a loading density of ~4 mg cm-2 were then punched and weighed. To evaluate the electrochemical properties, CR2032 coin-type cells were assembled in an argon-filled glovebox with the positive electrode, a glassy fiber separator, and sodium metal counter electrode in an electrolyte of 1.0 M sodium hexafluorophosphate (NaPF₆) in Diglyme. Electrochemical testing was conducted with an ARBIN cycler between 2 and 4 V vs Na/Na⁺ under varying current rates at room temperature. Theoretical capacity was calculated to be approximately 175 mA g⁻¹. Galvanostatic Intermittent Titration Technique (GITT) was completed using a three-electrode cell with an applied current rate of 8.75 mA g⁻¹ for 30 minutes followed by a 2 h relaxation to approach steady state.

Results. The three precursor materials were examined through SEM to evaluate the influence of chelation agent on particle morphology as shown in FIGS. 15A-15D. SEM analysis of FM14OH—NH3 revealed that the use of ammonia as a chelation agent does not result in the formation of secondary particles. The irregular particle morphology of FM14OH—NH3 closely resembles that of the NOC hydroxide sample, supporting the hypothesis that the inclusion of NH₃ and the resultant destabilizing Fe/Mn—NH₃ complexes inhibits the formation of spherical secondary particles, mimicking the morphology observed in systems without a chelating agent. In contrast, the introduction of the oxalate chelating agent results in the formation of large, spherical secondary particles densely packed with primary particles, as seen in FM14OH-OXA. This indicates that the Fe/Mn—C₂O₄ complexes are stable enough to allow for chelation during hydroxide synthesis. However, the presence of smaller conglomerations of primary particles suggests the incomplete formation of secondary particles. This may be due to the limitation of the small-scale CSTR that is being utilized (250 mL compared to the more commonly used 2 L or 3 L) or other factors that must be optimized (e.g., stirring rate, chelate concentration, pH, temperature, etc.). XRD and Rietveld refinement analysis of the FM14OH-OXA sample's crystal structure confirmed the formation of a single-phase Fe_{0.2}Mn_{0.8}(OH)₂ with space group P3̅m. Tap density measurements demonstrated the OXA, NH3, and NOC hydroxide samples to have tap densities of 1.18, 0.65, and 0.72 g cm⁻³, respectively. These results show oxalate's novel ability to successful chelate Fe/Mn ions during hydroxide synthesis, allowing for creation of spherical and tense particles. These findings highlight the unique capacity of oxalate to successfully chelate Fe²⁺ and Mn²⁺ ions during hydroxide precursor synthesis, enabling the formation of dense, spherical particles suitable for scalable positive electrode material production.

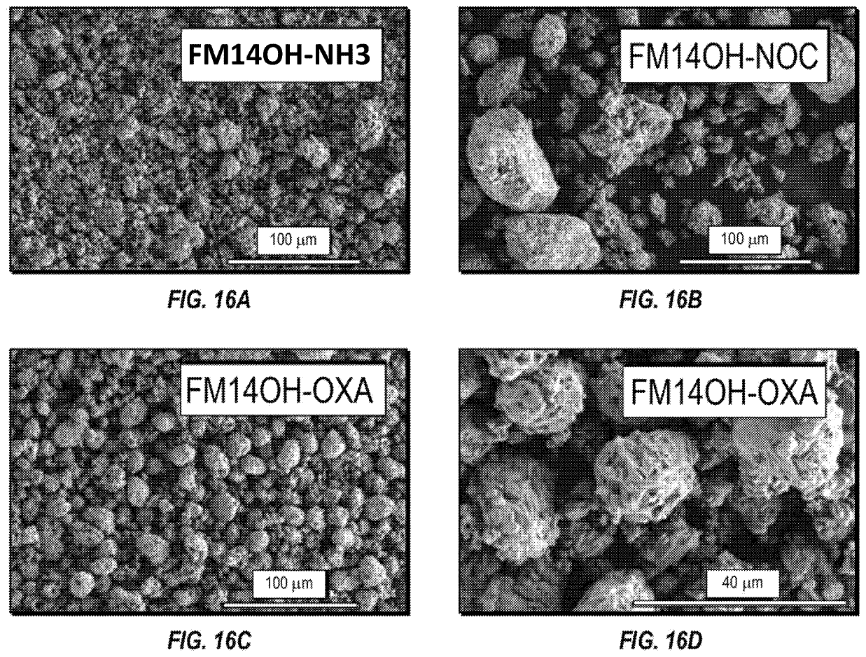

Following calcination, the three oxide materials were characterized using SEM as shown in FIGS. 16A-16D. Notably, despite having similar hydroxide morphology, the calcined FM14-NH3 and FM14-NOC materials display radically different morphologies. FM14-NH3 exhibits smaller, loosely aggregated secondary particles, along with a significant amount of isolated primary particles that failed to form secondary particles. In contrast, FM14-NOC consists of large secondary particles along with smaller secondary particles.

Among the three samples, FM14-OXA displays the most spherical and consistent particle morphology and size, enabled by the oxalate-chelated hydroxide precursor material. As seen in FIGS. 16A-16D, the FM14-OXA secondary particles are densely packed with plate-like primary particles.

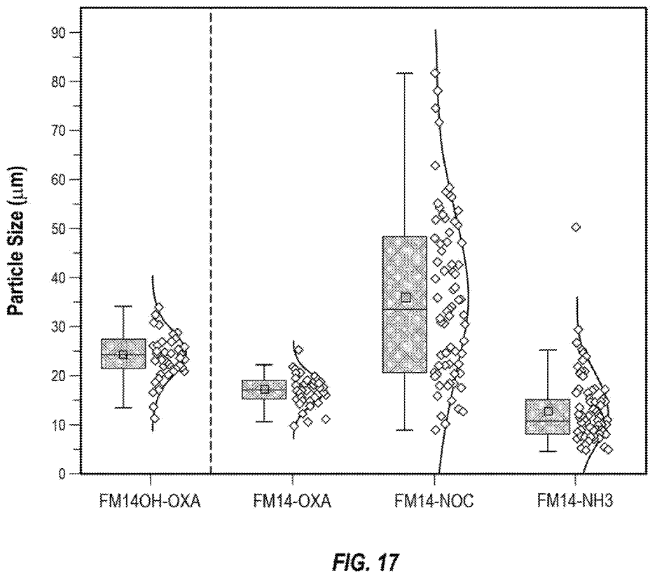

A comprehensive particle size analysis was conducted on a representative portion of FM14OH-OXA and the three oxides materials, with the resulting bar normal graph shown in FIG. 17 The FM14OH—NH3 and —NOC hydroxide samples were not analyzed, due to the lack of secondary particles within these materials; in addition, the primary particles that were not compacted into secondary particles in FM14-NH3 were not analyzed due to their negligible size. The FM14OH-OXA sample exhibits a mean secondary particle size of 24.4 μm, with an interquartile range of approximately 6 μm, indicating a tight particle size distribution. Upon calcinating, the resulting FM14-OXA retained a similar morphology with a slightly reduced mean size of 17.2 μm and narrower interquartile range of 4.1 μm. In contrast, FM14-NOC and FM14-NH3 displayed broader interquartile ranges (17.8 μm and 6.9 μm, respectively). These findings demonstrate oxalate's superior capability to promote controlled particle growth via stabilized TM²⁺-C₂O₄ complex, resulting in the growth of spherical, dense, uniform particles both before and after calcination, underscoring oxalate's potential use as a chelating agent in industrial scale manufacturing of LTMO positive electrode materials.

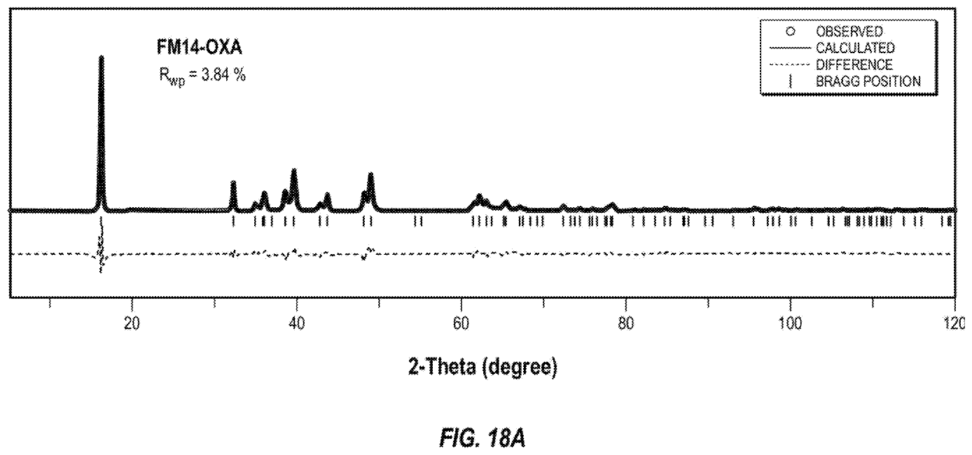

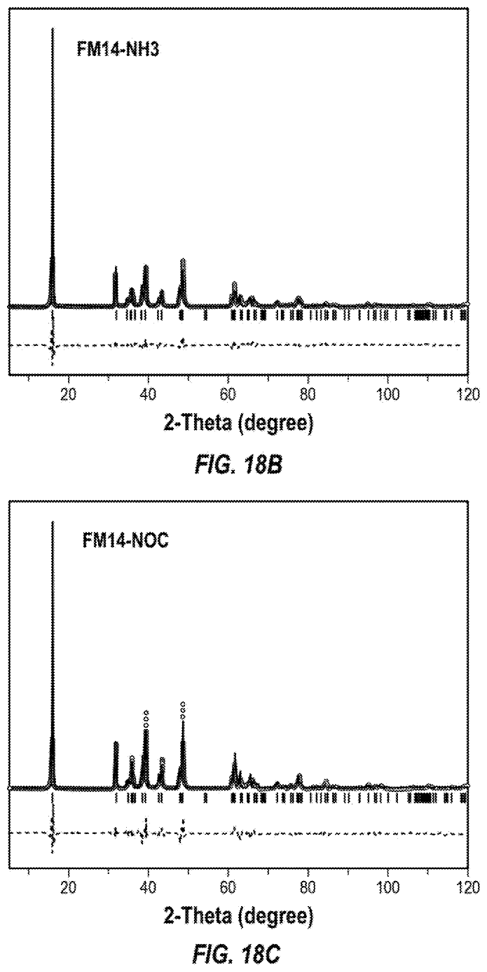

The crystal structure of the three oxides were characterized with XRD, followed by structural refinement via Rietveld Refinement, as shown in FIGS. 18A-18C. All three fitted oxide materials were successfully indexed to an orthorhombic P′2 structure, with the space group Cmcm. The refined patterns exhibited good agreement between the observed and calculated profiles, confirming the successful synthesis of the desired framework without impurities. Further, composition of the three oxides were validated by inductively coupled plasma mass spectroscopy (ICP-MS). The measured elemental composition closely matches that of the expected composition.

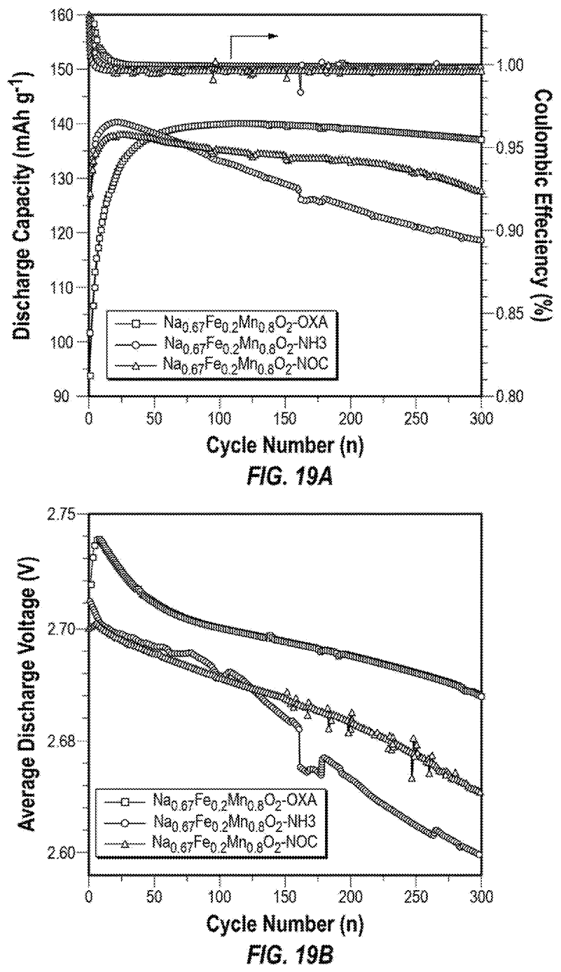

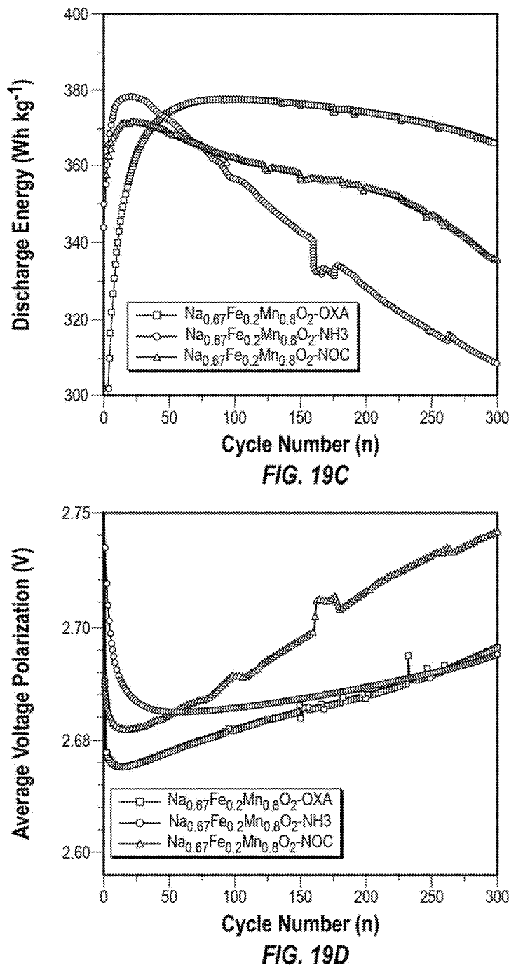

The three oxide materials were evaluated through galvanostatic cyling at 1 C (175 mA/g) between 2 and 4 V as shown in FIG. 19A. All samples displayed comparable maximum discharge capacities, with FM14-NOC, FM14-NH3, and FM14-OXA exhibiting 138.1, 143.3 and 140.0 mAh/g, respectively. Notably, all three materials initially exhibit gradual increases in their discharge capacity during cycling, likely due to the lack of electronically conductive transition metals (e.g., Ni, Co) and the large size of the particles, which hinder the diffusion of sodium ions from the center of particles due to poor wetting. This phenomenon was most pronounced in FM14-OXA, potentially due to its large and dense particles. The observed capacity increase is attributed to the continuous expansion and cracking of the FM14 particles over several cycles, which promotes increased electrode wetting and enhanced Na-ion accessibility. After 300 cycles, FM14-OXA maintains a high capacity of 137.1 mAh g⁻¹, outperforming FM14-NH3 (118.6 mAh g⁻¹) and FM14-NOC (127.6 mAh g⁻¹). The superior capacity retention of FM14-OXA is attributed to its uniform and densely packed particle morphology, which facilitates mechanical stability and enabling exceptional battery performance. In contrast, the poor cycling stability of FM14-NH3 is likely due to the increased surface area and non-uniform particle morphology, results in accelerated side reactions with electrolyte. FM14-NOC displays relatively stable electrochemical performance, most likely due to the lowered surface area enabled by the larger particles.

Average discharge voltages over 300 cycles are presented in FIG. 19B. FM14-NH3 and FM14-NOC display similar initial discharge potentials; however the greater side reactions with the electrolyte leads to a rapid deterioration of average discharge voltage for FM14-NH3. FM14-OXA maintained 3the highest average discharge voltage (2.700 V) after 300 cycles, compared to FM14-NH3 (2.598 V) and FM14-NOC (2.630 V). This higher average voltage, combined with a stable discharge capacity, yields a superior discharge energy after 300 cycles for the FM14-OXA material (366.1 Wh kg⁻¹) when compared to FM14-NH3 (308.2 Wh kg⁻¹) and FM14-NOC (335.5 Wh kg⁻¹) (see FIG. 19C). Despite having the highest initial hysteresis, FM14-OXA exhibits the lowest hysteresis growth rate during extended cycling (see FIG. 19D). After 300 cycles, the voltage hysteresis of the FM14-NOC material exceeds that of the FM14-OXA sample-likely due to the deterioration of transport properties due to loss of contact or defect formation (e.g. particle fractures, mechanical strain, deformation) during elongated cycling that is exasperated by the poor morphology of the FM14-NH3 and FM14-NOC materials. These findings underscore the critical role of morphological control-enables by novel use of oxalate as a chelating agent—in enhancing the elongated cycling performance of Mn/Fe-based positive electrode materials.

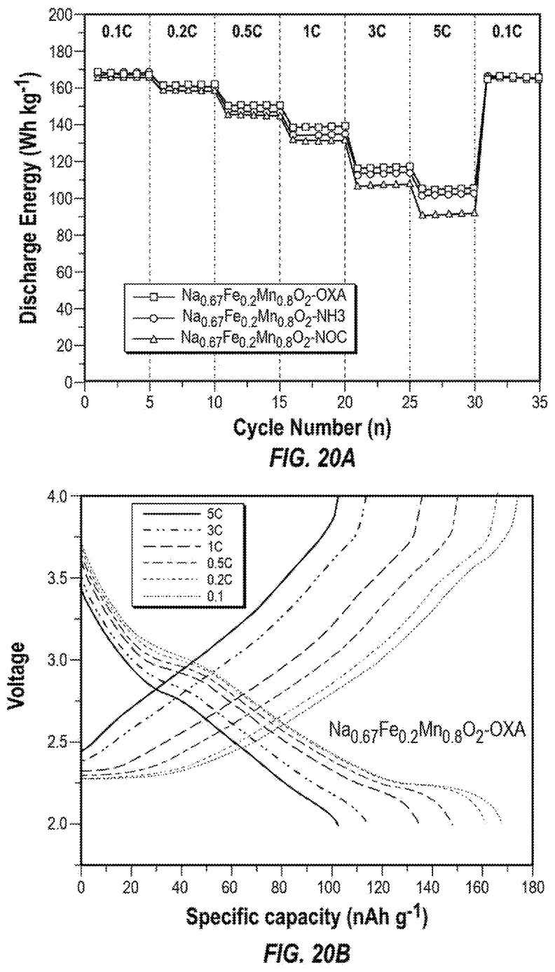

The kinetic properties of the materials were examined by rate performance tests. It was found the choice of chelation agent does not appear to significantly impact the rate performance of the FM14 oxides, with FM14-OXA and FM14-NH3 exhibiting near identical performance up to 5 C, and the FM14-NOC sample showing only a ~10 mAh g⁻¹ decrease at rapid charging currents as shown in FIG. 20A. However, it has been previously reported that an increase in tap density typically results in worsened Na ion kinetics. FM14-OXA, despite its precursor material having nearly double the tap density of the other two hydroxides, does not experience a significant decrease in Na-ion kinetics. This suggests that any adverse effects associated with the increased tap density are effectively mitigated by the optimized particle size and uniform morphology achieved in FM14-OXA. By examining the individual voltage profiles of FM14-OXA (see FIG. 20B), it can be observed that low-voltage plateau effectively disappears upon reaching 5 C, illustrating that the Mn^{3+/4+} redox that occurs at low-voltage results in a possible detrimental change to the structure that results in sluggish Na ion kinetics.

Galvanostatic intermittent titration technique (GITT) was performed on the oxides during discharge to probe the influence of depth of discharge (DoD) on Na-ion transport kinetics as shown in FIG. 21. All samples undergo a decrease in the Na-ion diffusional coefficient at a DoD of approximately 12.2% (corresponding to ~3.2 V), which is likely associated with the transformation of the previously seen “Z” phase to the original P′2 structure. Following the transition, the Na-ion kinetics rapidly increase and remain elevated until a DoD of ~75.6% (corresponding to ~2.3 V), after which the diffusion coefficient rapidly deteriorates due to the severe distortion caused by high-content of Jahn-Teller active Mn³⁺ ions at lower voltages. The difference in Na-ion diffusion behavior among the three materials are relatively minor, indicating that the increased density of the FM14-OXA material does not compromise sodium-ion kinetic performance.

The hydroxide materials and their resulting oxides were synthesized via alteration of the chelation agent (ammonia, no chelating agent, or oxalate). The inability of the Fe^{2+—NH}3 complex resulted in the FM14OH—NH3 material having no control over resulting particle morphology (similar to FM14OH—NOC), while the novel oxalate chelate was able to form spherical secondary particles with nearly double the tap density. The calcined FM14-NH3 and FM14-NOC oxide thus exhibited wide variety of particle sizes and morphologies, while FM14-OXA maintained the tightly packed spherical secondary particles that its precursor exhibited. The resulting galvanostatic cycling of the orthorhombically distorted P′2 oxides found that the FM14-OXA sample maintained a higher capacity, discharge voltage, and energy density over 300 cycles at 175 mA g⁻¹, owed to the optimized morphology of the oxalate-chelated system. Due to this reason, FM14-OXA also displayed similar Na ion kinetics to the other two samples, despite its higher tap density. This method offers a novel route for the scalable synthesis of earth abundant Na-ion Fe/Mn-based layered transition metal oxides with a competitive cycle life and energy density. Optimization of this technique and of the systems will further enhance the economic competitiveness of these materials as a competitor to contemporary Li-ion systems.

Another method may include synthesizing an iron-manganese-based hydroxide precursor for a sodium-ion layered transition metal oxide. During the synthesis of the iron-manganese-based hydroxide precursor, potassium oxalate may be used as a chelating agent. For example, the iron-manganese-based hydroxide precursor may be Fe_{0.2}Mn_{0.8}(OH)₂ and the potassium oxalate is K₂C₂O₄.

Synthesizing the iron-manganese-based hydroxide precursor may include forming a 1-mole-per-liter manganese sulfate (MnSO₄·H₂O), iron sulfate (FeSO₄·7H₂O), water solution. Forming the manganese sulfate, iron sulfate, water solution may include combining MnSO₄·H₂O and FeSO₄·7H₂O in a stoichiometric 1:4 molar ratio in an argon purged volumetric flask. Forming the solution may further include purging nanopure water with argon gas for 30 minutes to form de-aerated water. Forming the solution may also include pumping the de-aerated water into the flask. Finally, forming the solution may include dissolving the MnSO₄·H₂O and FeSO₄·7H₂O into the de-aerated water.

Next, synthesizing the iron-manganese-based hydroxide precursor may include adding the 1-mole-per-liter manganese sulfate, iron sulfate, water solution to a 0.5-mole-per-liter oxalate, water solution at a constant rate to form a precursor solution. The constant flow rate may be 0.1 grams per minute. A constant molarity of 0.5-mole-per-liter of potassium oxalate within the precursor solution may be maintained by adding a 0.75-mole-per-liter potassium oxalate, water solution to the precursor solution. Likewise, a constant pH of 10.5 within the precursor solution may be maintained by adding a 0.75-mole-per-liter potassium oxalate, water solution to the precursor solution.

Forming the precursor solution may be performed within a reactor vessel. The contents of the reactor vessel may be kept under constant argon flow and kept at a temperature of 60 degrees Celsius for a residence time of 10 hours.

Synthesizing the iron-manganese-based hydroxide precursor may further include filtering the precursor solution, mixing the precursor solution for 10 hours, rinsing the precursor solution with 3 L of 30-minute-argon-purged nanopure water, drying the rinsed precursor solution in an ambient oven at 100 degrees Celsius for approximately 1 hour, and transferring the precursor solution to a vacuum oven at 70 degrees Celsius to dry for at least 8 hours to form the precursor. The solution may then be passed through a 150-micrometer sieve. The precursor may then be stored in an argon-filled glovebox to avoid oxidation.

The method may further include mixing the precursor with Na₂CO₃ in a mortar and pestle for 15 minutes to form mixed powders of the precursor and the Na₂CO₃. The method may include calcining the mixed powders at 900 degrees Celsius for 15 hours with a heating rate of 3 degrees Celsius per minute to form a layered transition metal oxide. A resulting layered transition metal oxide may be Na_{0.67}Fe_{0.2}Mn_{0.8}O₂.

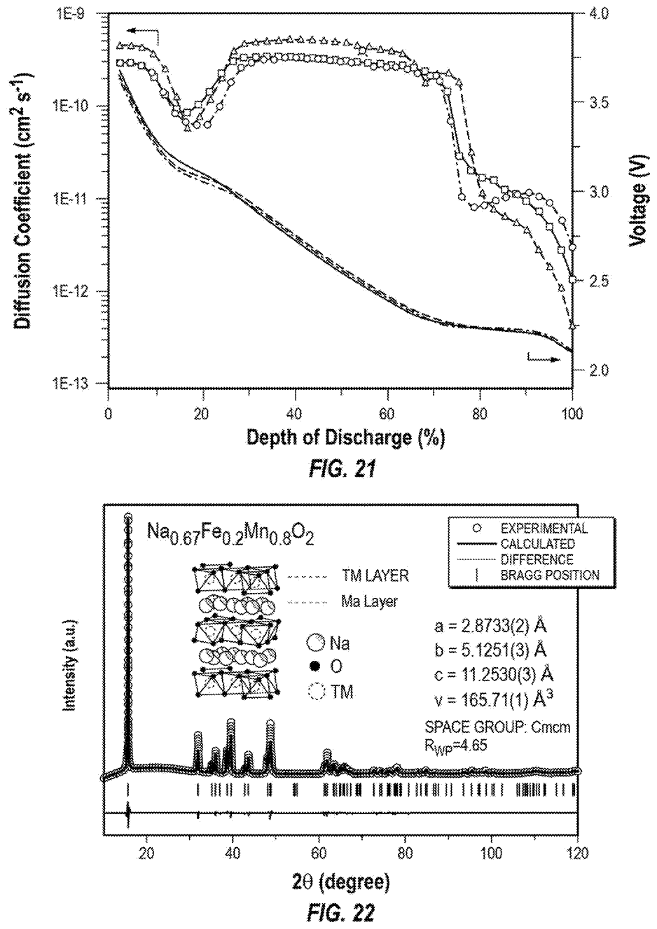

FIG. 22 is refined XRD pattern of the single crystal Na_{0.67}Fe_{0.2}Mn_{0.8}O₂ made by molten salt method.

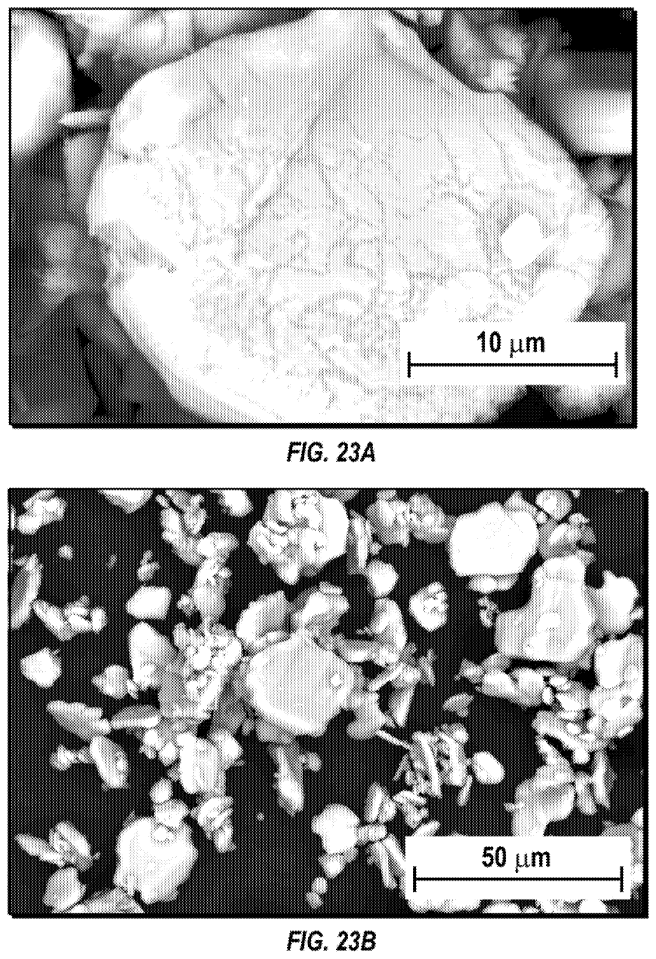

FIGS. 23A-23B are SEM images of the as-prepared Na_{0.67}Fe_{0.2}Mn_{0.8}O₂ made by molten salt method.

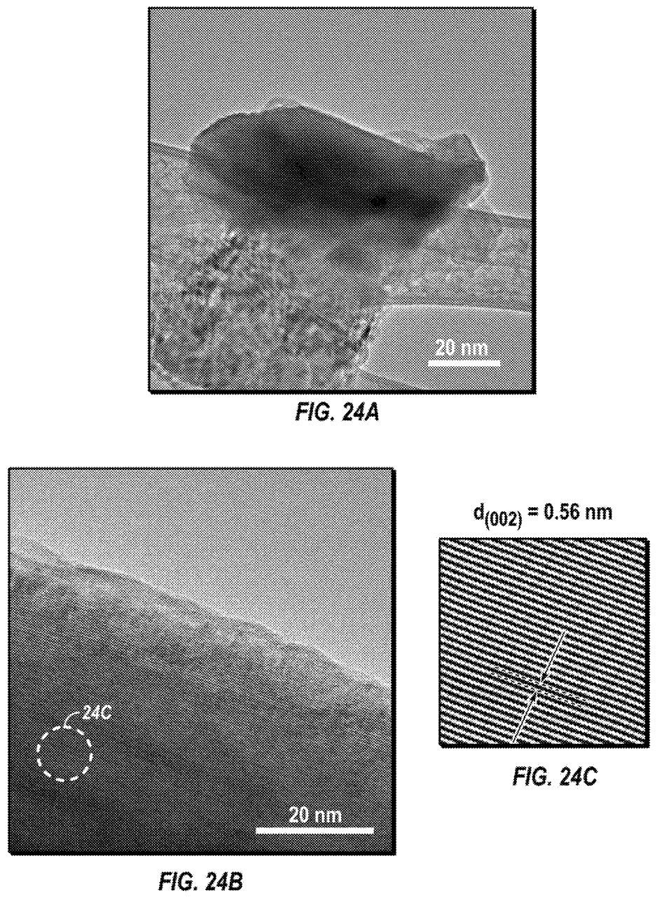

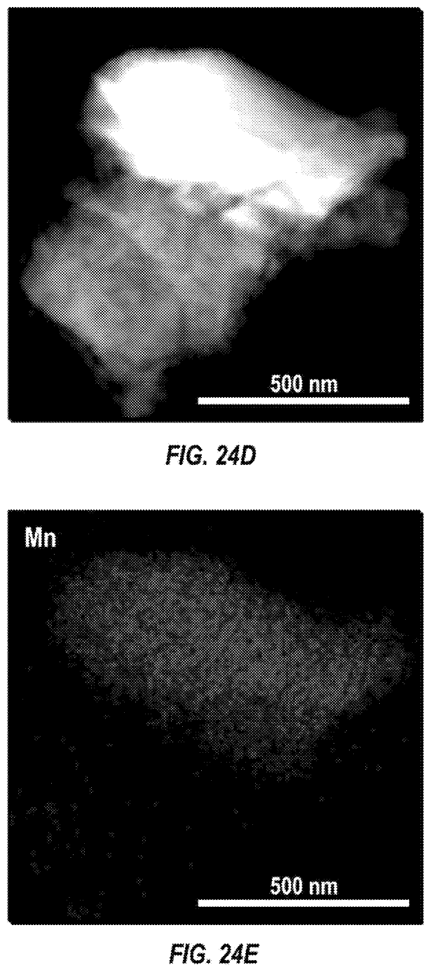

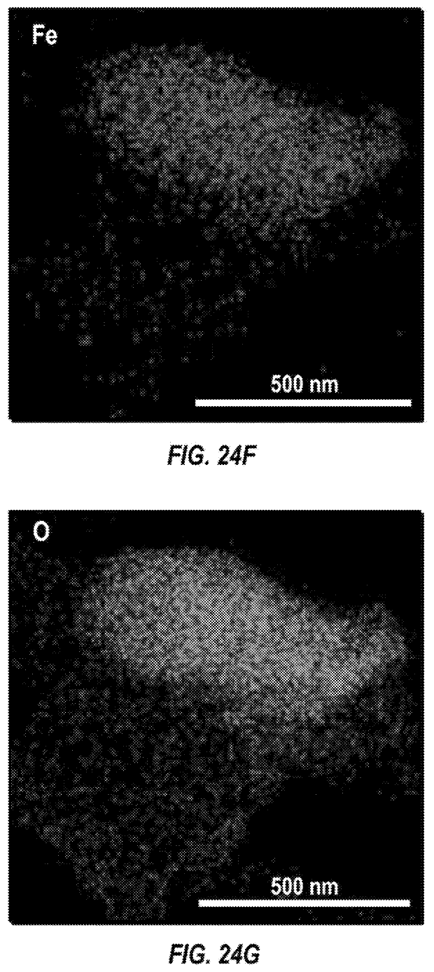

FIGS. 24A-24G are TEM and EDS images of as-prepared Na_{0.67}Fe_{0.2}Mn_{0.8}O₂ made by molten salt method. Lattice fringes with the interlayer spacing of 5.6 Å are indexed to the (002) plane. EDS images show uniform distribution of Ni, Mn, and O among the sample.

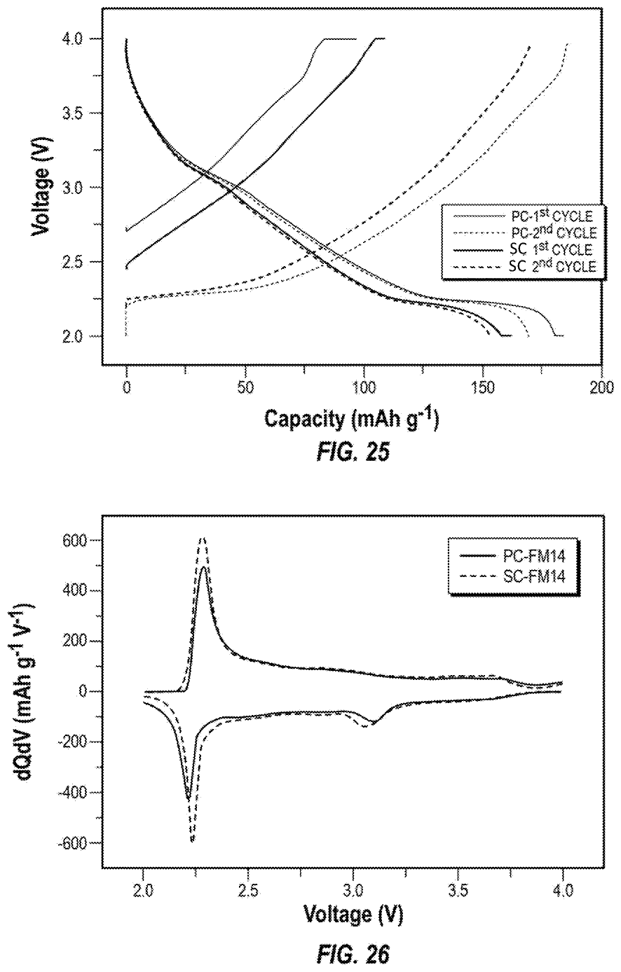

FIG. 25 is comparison of the voltage profiles of the polycrystalline (PC) and the single crystal (SC) electrodes.

FIG. 26 is the differential capacity over voltage (dQ/dV) curves of PC-FM14 and SC-FM14 electrodes.

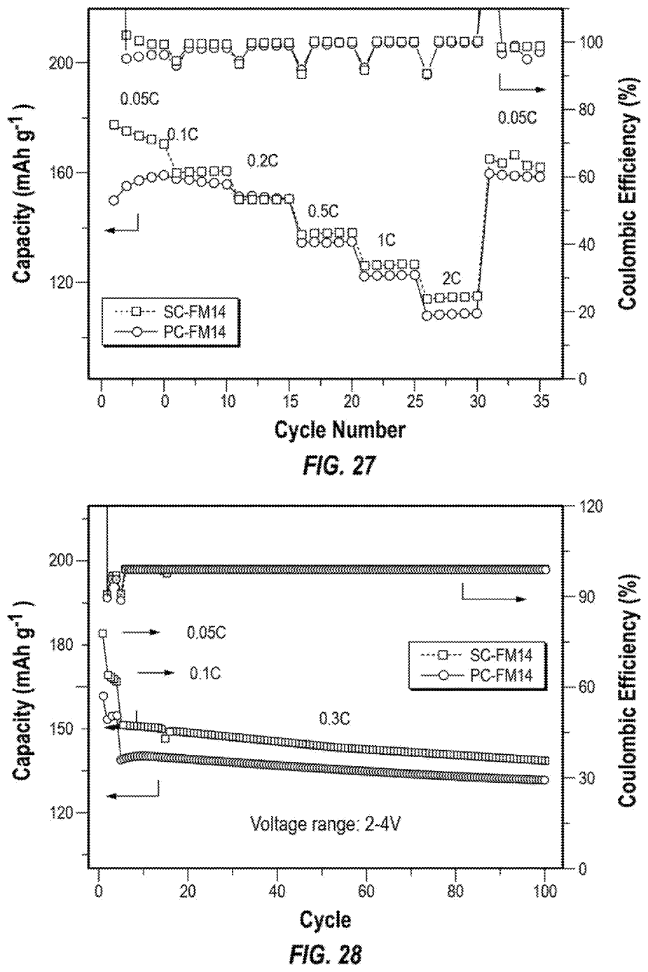

FIG. 27 is the rate capability comparison of PC-FM14 and SC-FM14 electrodes.

FIG. 28 is cycling performance of PC-FM14 and SC-FM14 electrodes.

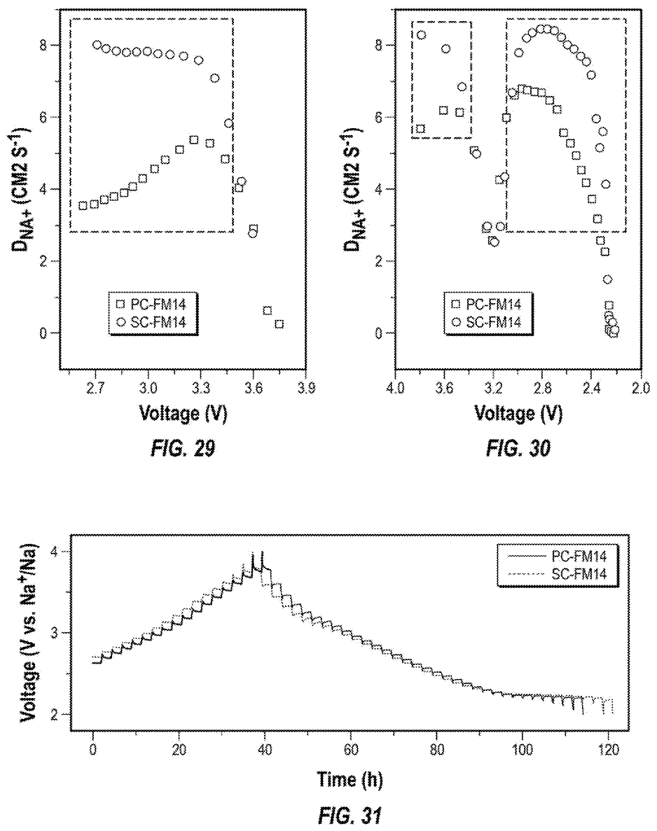

FIG. 29 is the Na⁺ diffusion coefficients of PC-FM14 and SC-FM14 electrodes during charge.

FIG. 30 is the Na⁺ diffusion coefficients of PC-FM14 and SC-FM14 electrodes during discharge.

FIG. 31 is Galvanostatic Interruption Titration Technique measurements of PC-FM14 and SC-FM14 electrodes.

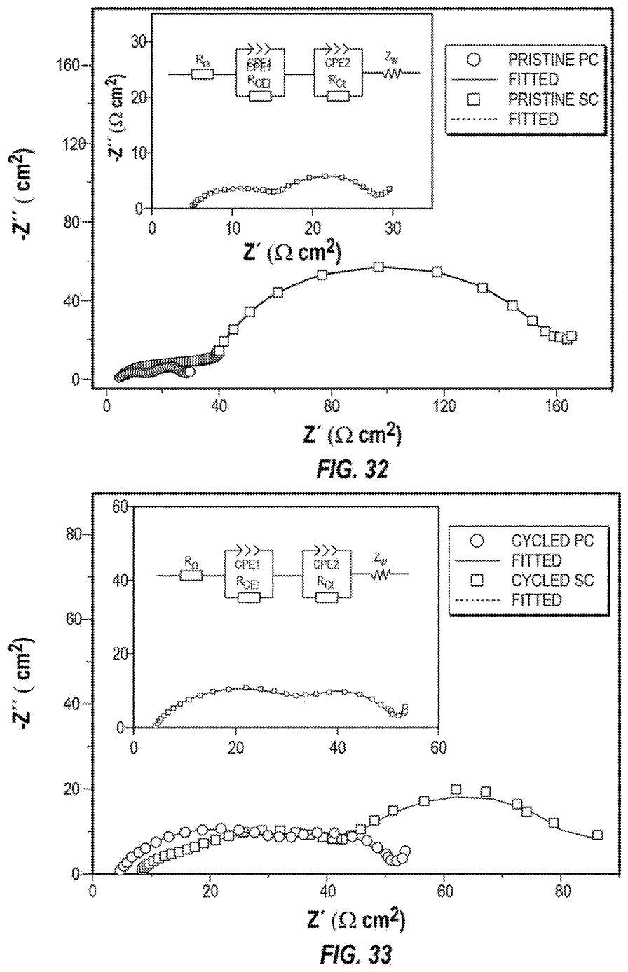

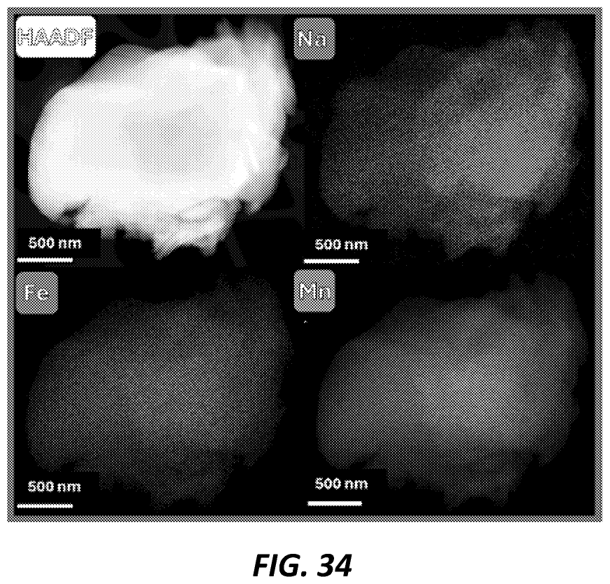

FIG. 32 is the electrochemical impedance spectroscopy of pristine PC-FM14 and SC-FM14 electrodes.

FIG. 33 is the electrochemical impedance spectroscopy of cycled PC-FM14 and SC-FM14 electrodes.

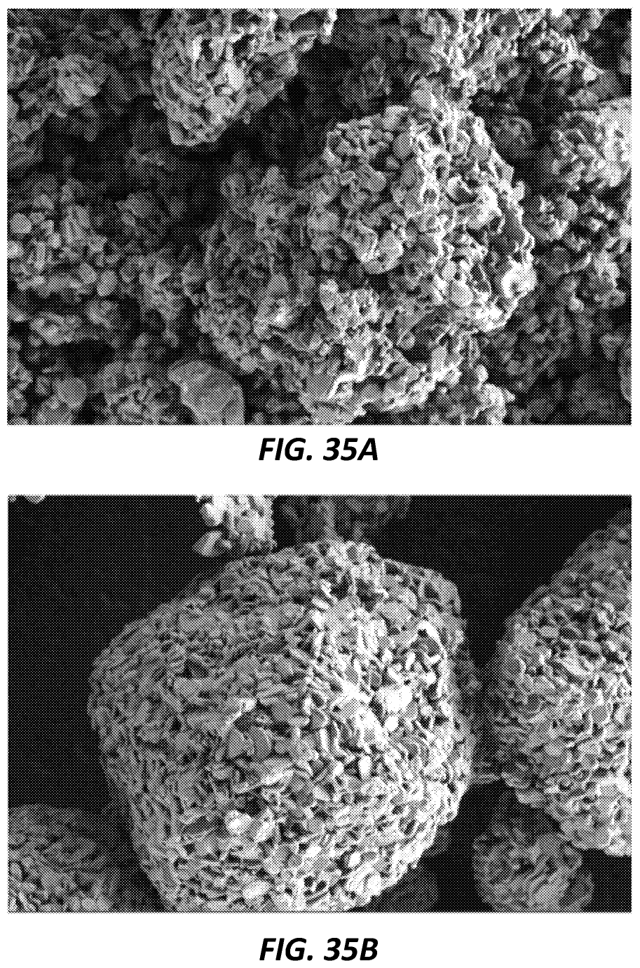

Additional results include the following. The three precursor materials were examined by SEM to evaluate the influence of the chelating agent on particle morphology as shown in FIGS. 15-16. SEM analysis of FM14OH—NH3 revealed that the use of ammonia as a chelation agent does not yield the formation of secondary particles. The irregular particle morphology of FM14OH—NH3 closely resembles that of the FM14OH—NOC hydroxide sample, supporting the hypothesis that the inclusion of NH₃ leads to unstable Fe/Mn—NH₃ complexes, which prevents the formation of spherical secondary particles, mimicking the morphology observed in systems without a chelating agent. In contrast, the introduction of the oxalate chelating agent results in the formation of large, spherical secondary particles densely packed with primary particles, as seen in FM14OH—OXA. This indicates that the Fe/Mn—C₂O₄ complexes are stable during hydroxide synthesis. The FM14OH—OXA, FM14OH—NH3, and FM14OH—NOC hydroxide samples possess tap densities of 1.18, 0.65, and 0.72 g cm⁻³, respectively. These results highlight oxalate's ability to successfully chelate Fe/Mn ions during hydroxide synthesis, allowing for creation of spherical and dense precursor particles. Following calcination, the three Na_{0.67}Fe_{0.2}Mn_{0.8}O₂ (FM14) oxide materials were characterized by using SEM (FIGS. 15-16). Notably, despite having similar hydroxide precursor morphology, the calcined FM14-NH3 and FM14-NOC materials display different morphologies. FM14-NH3 exhibits a collection of large- and medium-sized secondary particles, along with a significant amount of isolated primary particles. One reason for the existence of the isolated primary particles in FM14-NH3 could be that the loosely agglomerated large particles exhibit poor mechanical stability, shattering either during quenching or upon subsequent light grinding of the oxide materials. In contrast, FM14-NOC consists of large secondary particles along with smaller secondary particles and fractured primary particles, though to a lesser extent. These larger particles result from fusion of the primary hydroxide particles during calcination at elevated temperatures. Notably, the larger particles in FM14-NOC appear to be much denser than those in the FM14-NH3 sample (FIG. 35). This most likely results in the smaller number of primary particles contained within FM14-NOC, as the framework of these particles is more robust. FM14-OXA exhibits uniformly shaped spherical secondary particles that are tightly packed with hexagonal plate-like primary particles, which aligns closely with the morphology characterized in the precursor FM14OH—OXA.

A comprehensive particle size analysis was conducted on a representative portion of FM14OH—OXA and the three FM14 oxide materials (FIG. 17 and Table IV). The FM14OH—NH3 and FM14OH—NOC hydroxide samples were not analyzed due to the lack of secondary particles within these materials; in addition, the primary particles that were not compacted into secondary particles in FM14-NH3 and FM14-NOC were not analyzed due to their negligible size. The FM14OH—OXA sample exhibits a mean secondary particle size of 24.4 μm with an interquartile range of approximately 6 μm, indicating a narrow particle size distribution. Upon calcination, the resulting FM14-OXA retained a similar morphology with a slightly reduced mean size of 17.240 μm and a narrower interquartile range of 5.111 μm. In contrast, FM14-NH3 and FM14-NOC exhibited larger mean sizes (26.544 and 39.352 μm, respectively) and broader interquartile ranges (30.352 and 30.464 μm, respectively). These findings demonstrate oxalate's superior capability to promote controlled particle growth via stabilized TM²⁺—C₂O₄ complex, resulting in the growth of spherical, dense, uniform particles both before and after calcination.

TABLE IV
Properties of the three oxide samples from SEM and BET

| | Mean Size | Interquartile | Surface Area | Pore Volume |
|---|---|---|---|---|
| | (μm) | Range (μm) | (cm³ g⁻¹) | (mm³ g⁻¹) |
| FM14-NH3 | 26.544 | 30.352 | 0.6659 | 2.917 |
| FM14-NOC | 39.352 | 30.464 | 0.5388 | 2.065 |
| FM14-OXA | 17.240 | 5.111 | 0.3324 | 1.01 |

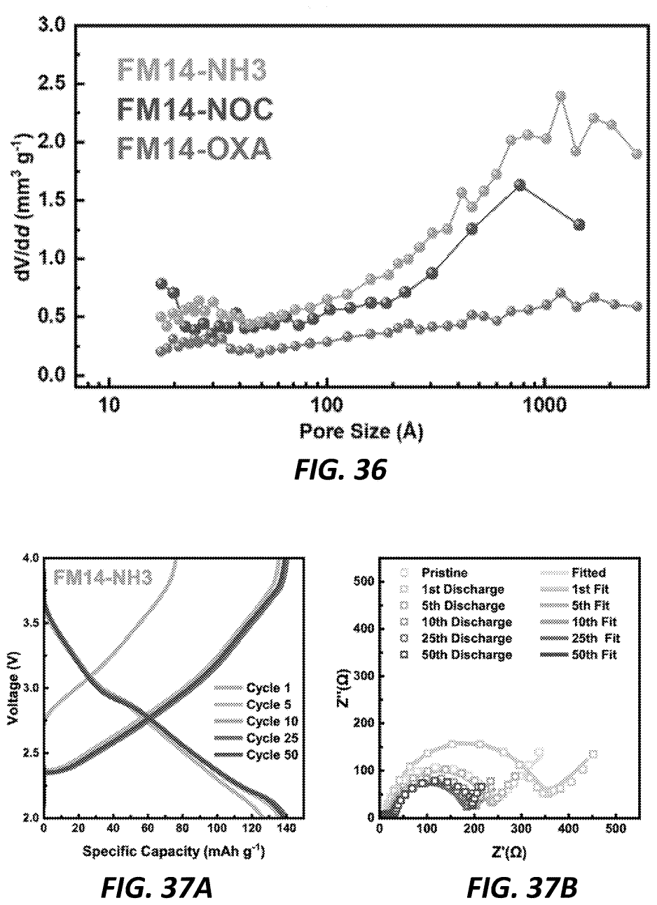

BET analysis was performed on the three oxide materials to further explore the particle characteristics (FIG. 36, Table IV). Among the three samples, FM14-NH3 displays the highest surface area and largest pore volume (0.6659 cm³ g⁻¹ and 2.917 mm³ g⁻¹, respectively). This is attributed to the significant number of smaller primary particles, which are less prevalent in FM14-NOC and nearly absent in FM14-OXA, as well as the more porous secondary particles. FM14-NOC displays a lower surface area and pore volume due to its reduced fraction of small particles and compact secondary particles (0.5388 cm³ g⁻¹ and 2.065 mm³ g⁻¹, respectively).FM14-OXA possesses the lowest surface area and pore volume of the three (0.3324 cm³ g⁻¹ and 1.010 mm³ g⁻¹, respectively), consistent with its dense, medium-sized particle morphology.

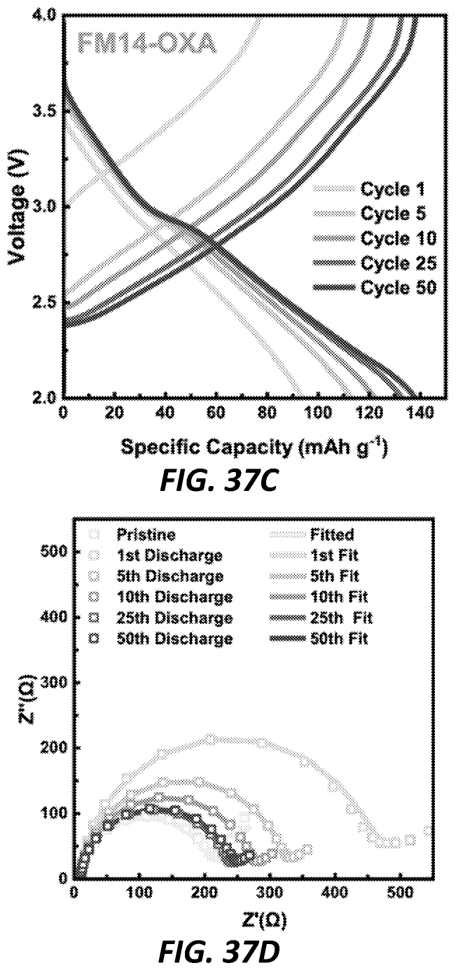

The voltage profile of the first 50 galvanostatic cycles at a 1 C (175 mA g⁻¹) rate between 2 and 4 V for the three FM14 oxide samples is shown in FIG. 37. All samples displayed comparable maximum discharge capacities, with FM14-NOC, FM14-NH3, and FM14-OXA exhibiting capacities of 143.3, 138.1, and 140.0 mAh g⁻¹, respectively. Notably, all three electrodes displayed initially a gradual capacity increase during cycling, likely due to the low electrical conductivity in Fe/Mn-based LTMOs and the large particle size, which hinder the Na⁺ diffusion to the center of particles due to poor wetting. This phenomenon was most pronounced in FM14-OXA, due to its significantly lower initial surface area and pore volume. To examine this phenomenon, EIS measurements were then performed on the three materials at pristine state and after the 1st, 5th, 10th, 25th, and 50th cycles at full sodiation. Nyquist plots, which are fitted to the corresponding equivalent circuit, are presented in FIG. 37. Each material exhibits one small semicircle near the high frequency region, one larger semicircle in the intermediate frequency region, and an inclined line in the low frequency region. These features correspond to the ohmic resistance (R_{Ω}) at the intercept, cathode electrolyte interface (CEI) resistance (R_{cei}), charge transfer resistance (R_{ct}), and Warburg impedance (Z_{w}). The R_{cei} reflects the CEI growth and decomposition, while the R_{ct} is associated with Na⁺ charge transfer resistance at the interface between the electrode and the electrolyte. Upon reaching the fully sodiated state after the first cycle, the R_{ct} increased drastically for all three samples. This behavior is consistent with both the more sluggish Na-ion kinetics expected at high sodium concentration and potential phase transformations that occur. Among the three, FM14-OXA exhibits the most pronounced increase in charge transfer resistance due to its lower surface area and pore volume impedes electrolyte penetration into the particle interior. This result is consistent with what is observed from the BET and SEM and suggests the charge transfer resistance is higher initially in the FM14-OXA due to the reduced amount of surface active sodium sites. This change is far less dramatic in FM14-NH3 and FM14-NOC due to their higher surface area and greater electrolyte accessibility. These findings align with the voltage profile results (FIG. 37A), where FM14-OXA exhibits an initial specific capacity lower than that of the other two materials.

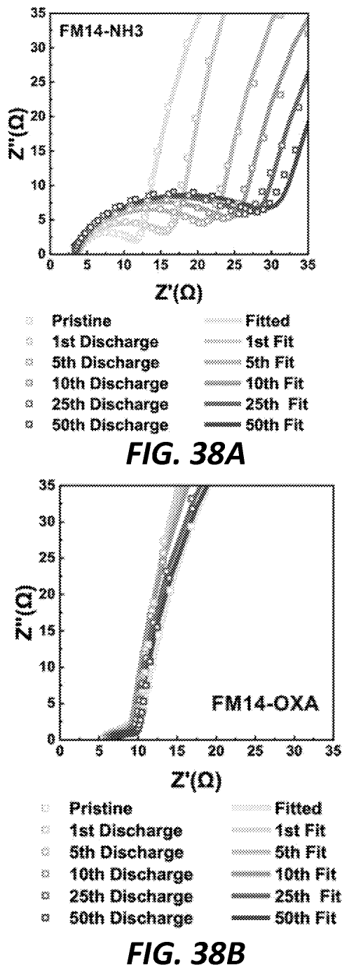

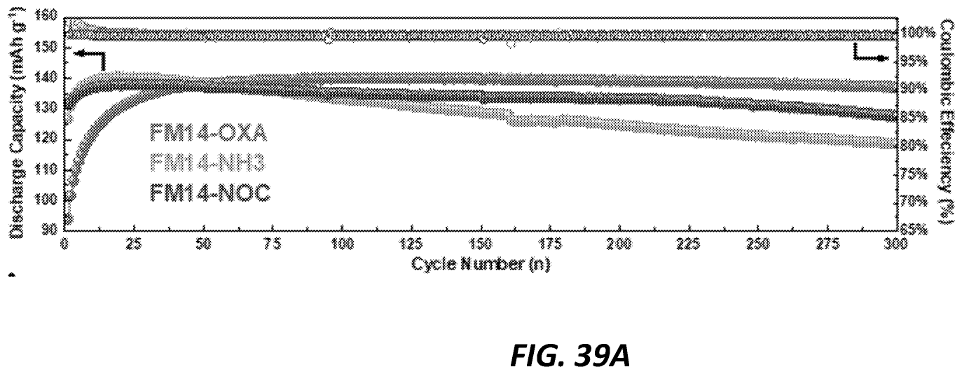

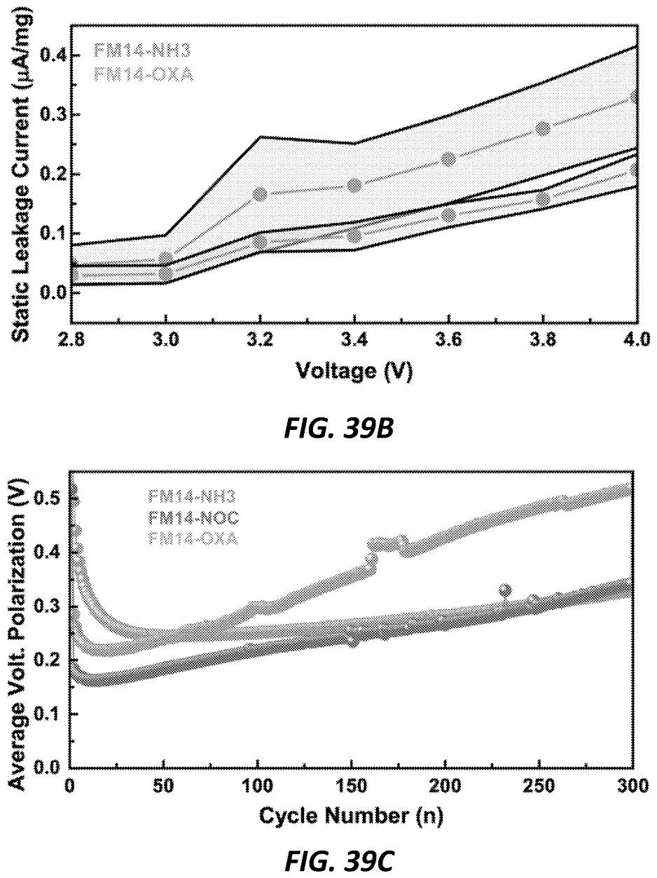

With subsequent cycling, all three electrodes exhibit a significant decrease in their R_{ct} values accompanied by a progressive increase in specific capacity. This correlation suggests that moderate volume fluctuations during repeated sodiation/desodiation induce microcrack formation and/or pore expansion, facilitating improved electrolyte wetting and ion transport within the particle. Although FM14-NH3 and FM14-NOC contain a population of small particles, they also possess large particles that initially restrict electrolyte access, explaining their gradual capacity increase. FM14-OXA, however, demonstrates the most pronounced capacity increase and the largest corresponding reduction in R_{ct}. Given its initially low surface area and pore volume, FM14-OXA likely contains the greatest fraction of previously inaccessible Na⁺ sites that become electrochemically active as the wetting improves. Beyond approximately 25 cycles, the FM14-OXA rate of capacity increases and R_{ct} decreases slowly, indicating near-complete electrolyte penetration. After 50 cycles (at which the capacity stops significantly increasing at 1 C), FM14-OXA's R_{ct} progressively decreases to near those of FM14-NH3 and FM14-NOC, suggesting comparable kinetics between the three samples. In addition, R_{cei} increases drastically in FM14-NH3, whereas the growth of R_{cei} is relatively small in FM14-NOC and almost unchanged in FM14-OXA (FIG. 38 and Table V). This trend suggests that the extent to which detrimental electrolyte degradation occurs at the electrode surface is exacerbated by FM14-NH3's greater surface area and pore volume. After 300 cycles, FM14-OXA maintains a high capacity of 137.1 mAh g⁻¹, outperforming FM14-NH3 (118.6 mAh g⁻¹) and FM14-NOC (127.6 mAh g⁻¹) (FIG. 39A). The superior capacity retention of FM14-OXA (97.9%) aligns with what was observed in EIS—the suppression of detrimental reactions with the electrolyte serves to enhance the stability of the electrochemical system. In addition, the uniform and densely packed particle morphology enhances the mechanical stability of the system upon elongated sodiation/desodiation. In contrast, the poor cycling stability of FM14-NH3 (82.8%) caused by the chemo-mechanical heterogeneity induced by nonuniform particle morphology as well as the increased particle surface area results in accelerated side reactions with the electrolyte. FM14-NOC displays relatively stable electrochemical performance (92.4%), as the smaller surface area suppresses these detrimental phenomena but not to the extent observed in FM14-OXA.

TABLE V
Rₑ, R_{cei}, and R_{ct} values from the fitting of the EIS spectra for each sample.

| | | 1^{st} | 5^{th} | 10^{th} | 25^{th} | 50^{th} |
|---|---|---|---|---|---|---|
| | Pristine | Discharge | Discharge | Discharge | Discharge | Discharge |
| FM14-NH3 | | | | | | |
| Rₑ | 3.413 | 3.356 | 3.26 | 3.19 | 3.04 | 2.095 |
| R_{cei} | 8.4343 | 13.07 | 18.91 | 22.14 | 24.79 | 30.19 |
| R_{ct} | 200.7 | 313.6 | 206 | 169.5 | 152.7 | 140.9 |
| FM14-NOC | | | | | | |
| Rₑ | 12.09 | 12.33 | 12.33 | 12.84 | 12.82 | 13.19 |
| R_{cei} | 3.612 | 3.997 | 4.839 | 4.81 | 6.454 | 8.024 |
| R_{ct} | 108.4 | 296.2 | 221.8 | 188.4 | 162.8 | 156.2 |
| FM14-OXA | | | | | | |
| Rₑ | 5.704 | 5.803 | 5.832 | 5.954 | 6.415 | 6.922 |
| R_{cei} | 4.233 | 3.872 | 3.493 | 2.964 | 2.636 | 2.53 |
| R_{ct} | 188.1 | 434 | 302.5 | 252.6 | 213.8 | 221.2 |

Static leakage current measurements were performed on FM14-NH3 and FM14-OXA after 3 cycles to quantitatively compare the side reaction rate of the two materials with the electrolyte (FIG. 39). At low voltages (2.8 and 3.0 V), the difference between the static leakage currents is statistically insignificant. Upon reaching 3.2 V, the FM14-NH3 sample experiences a greater increase in the static leakage current than the FM14-OXA sample. The higher static leakage current of the FM14-NH3 material is associated with a higher degree of side reaction with the electrolyte as observed in EIS. Despite having the highest initial voltage polarization, it rapidly decreases as R_{ct} decreases during initial cycling. After 300 cycles, FM14-OXA exhibits the lowest hysteresis growth rate (FIG. 39). In contrast, the voltage hysteresis of both FM14-NOC and FM14-NH3 exceeds that of the FM14-OXA sample-likely due to loss of contact or defect formation (e.g., particle fractures, mechanical strain, deformation) during elongated cycling that is aggravated by the poor morphology of the FM14-NH3 and FM14-NOC materials, as well as the formation of insulative CEI on the surface of the particles. These results highlight the critical importance of morphological control, as achieved through the use of oxalate as a chelating agent.

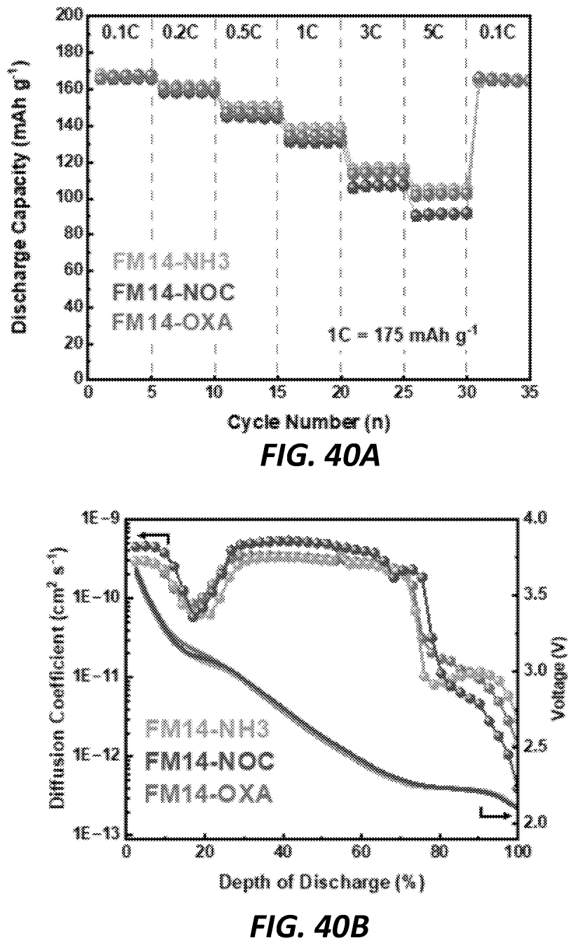

The kinetic properties of the materials were examined by rate capability tests (FIG. 40A). It was found that the choice of chelating agent does not appear to significantly affect the rate performance of the FM14 electrodes, with FM14-OXA and FM14-NH3 exhibiting nearly identical performance up to 5 C, and the FM14-NOC sample showing only an ~10 mAh g⁻¹ decrease at rapid charging currents. This is in spite of the more dense particles of FM14-OXA, whose lower surface area, higher tap density, and reduced pore area should result in more tortuous Na⁺ diffusion. However, though FM14-OXA exhibits an initially higher charge transfer resistance, repeated sodiation/desodiation induces microcracking and pore formation that enhance electrolyte wetting and activate previously inaccessible Na⁺ sites in FM14-OXA that makes its Na-ion kinetics similar to that of the other two materials, as observed in EIS.

Another method may include synthesizing an iron-manganese-based hydroxide precursor for a sodium-ion layered transition metal oxide. During the synthesis of the iron-manganese-based hydroxide precursor, potassium oxalate may be used as a chelating agent. For example, the iron-manganese-based hydroxide precursor may be Fe_{0.2}Mn_{0.8}(OH)₂ and the potassium oxalate is K₂C₂O₄.

Although various embodiments have been shown and described, the present disclosure is not so limited and will be understood to include all such modifications and variations would be apparent to one skilled in the art.

What is claimed is:

1. A method for synthesizing a layered transition metal oxide material comprising:
grinding a salt, a first transition metal oxide, a second transition metal oxide, and an alkali metal carbonate together with a dispersant to form a mixture;
calcining the mixture to form a calcined mixture;
cooling the calcined mixture to room temperature.

2. The method of claim 1, wherein the salt is NaCl.

3. The method of claim 1, wherein the first transition metal oxide is nickel oxide (NiO), wherein the second transition metal oxide is manganese oxide (Mn₂O₃), and wherein the alkali metal carbonate is sodium carbonate (Na₂CO₃).

4. The method of claim 1, wherein grinding the first transition metal oxide, the second transition metal oxide, and the alkali metal carbonate together comprises hand grinding for 20 minutes in an agate mortar in a molar ratio of 1:1:1.03 respectively, wherein the alkali metal carbonate includes a 5 percent excess over the first transition metal oxide and the second transition metal oxide, to account for volatilization losses of a sodium source.

5. The method of claim 1, wherein calcining the mixture is performed in a furnace at 1000 °C for 15 hours under an air atmosphere.

6. The method of claim 1, further comprising adding more of the alkali metal carbonate comprises adding 5% Na₂CO₃ to compensate for losses during the calcination process.

7. The method of claim 6, further comprising reheating and re-cooling the calcined mixture comprises heating to 750 °C for 10 hours in air and then cooling to room temperature.

8. The method of claim 1, further comprising transferring the layered transition metal oxide material to a glovebox to prevent air exposure.

9. A method comprising:
synthesizing an iron-manganese-based hydroxide precursor for a sodium-ion layered transition metal oxide,
wherein during the synthesis of the iron-manganese-based hydroxide precursor, potassium oxalate is used as a chelating agent.

10. The method of claim 9, wherein the iron-manganese-based hydroxide precursor is Fe_{0.2}Mn_{0.8}(OH)₂, and wherein the oxalate is K₂C₂O₄.

11. The method of claim 9, wherein synthesizing the iron-manganese-based hydroxide precursor comprises:
adding a 1-mole-per-liter manganese sulfate (MnSO₄·H₂O), iron sulfate (FeSO₄·7H₂O), water solution to a 0.5-mole-per-liter oxalate, water solution at a constant rate to form a precursor solution.

12. The method of claim 11, wherein the constant flow rate is 0.1 grams per minute.

13. The method of claim 11, wherein synthesizing the iron-manganese-based hydroxide precursor further comprises:
maintaining a constant molarity of 0.5-mole-per-liter of potassium oxalate within the precursor solution by adding a 0.75-mole-per-liter potassium oxalate, water solution to the precursor solution.

14. The method of claim 11, wherein synthesizing the iron-manganese-based hydroxide precursor further comprises:
maintaining a constant pH of 10.5 within the precursor solution by adding a 0.75-mole-per-liter potassium oxalate, water solution to the precursor solution.

15. The method of claim 11, wherein adding the 1-mole-per-liter manganese sulfate, iron sulfate, water solution to the 0.5-mole-per-liter potassium oxalate, water solution is performed within a reactor vessel, wherein contents of the reactor vessel are kept under constant argon flow, and wherein the contents of the reactor vessel are kept at a temperature of 60 degrees Celsius for a residence time of 10 hours.

16. The method of claim 11, wherein synthesizing the iron-manganese-based hydroxide precursor further comprises:
filtering the precursor solution;
mixing the precursor solution for 10 hours;
rinsing the precursor solution with 3 L of 30-minute-argon-purged nonopure water;
drying the rinsed precursor solution in an ambient oven at 100 degrees Celsius for approximately 1 hour;
transferring the precursor solution to a vacuum oven at 70 degrees Celsius to dry for at least 8 hours to form the precursor; and
passing the precursor through a 150 micrometer sieve.

17. The method of claim 16, further comprising storing the precursor in an argon-filled glovebox to avoid oxidation.

18. The method of claim 9, further comprising:
mixing the precursor with Na₂CO₃ in a mortar and pestle for 15 minutes to form mixed powders of the precursor and the Na₂CO₃; and
calcining the mixed powders at 900 degrees Celsius for 15 hours with a heating rate of 3 degrees Celsius per minute to form a layered transition metal oxide.

19. The method of claim 18, wherein a resulting layered transition metal oxide is Na_{0.67}Fe_{0.2}Mn_{0.8}O₂.

20. The method of claim 18, further comprising:
quenching the layered transition metal oxide;
cleaning off residual salts from the layered transition metal oxide by centrifuging the transition metal oxide with ethanol at 9000 rpm for 5 minutes, 3 times with agitation between each time;
drying the transition metal oxide in a vacuum oven at 70 degrees Celsius for 1 to 2 hours.

21. The method of claim 11, wherein synthesizing the iron-manganese-based hydroxide precursor further comprises forming the 1-mole-per-liter manganese sulfate (MnSO₄·H₂O), iron sulfate (FeSO₄·7H₂O), water solution by:
combining MnSO₄·H₂O and FeSO₄·7H₂O in a stoichiometric 1:4 molar ratio in an argon purged volumetric flask;
purging nanopure water with argon gas for 30 minutes to form de-aerated water;
pumping the de-aerated water into the flask; and
dissolving the MnSO₄·H₂O and FeSO₄·7H₂O into the de-aerated water.

22. A material comprising:
an iron-manganese-based hydroxide precursor (Fe_{0.2}Mn_{0.8}(OH)₂) for a sodium-ion layered transition metal oxide synthesized using potassium oxalate as a chelating agent.

23. The material of claim 22, wherein a tap density of the iron-manganese-based hydroxide precursor is at least 1.18 grams per cubic centimeter.

24. The material of claim 22, wherein a mean secondary particle size of the iron-manganese-based hydroxide precursor is 24.4 micrometers, with an interquartile range of approximately 6 micrometers.

25. The material of claim 22, wherein, in response to calcining the iron-manganese-based hydroxide precursor, a resulting iron-manganese material has a mean secondary particular size of 17.2 micrometers, with an interquartile range of 4.1 micrometers.

26. The material of claim 22, wherein, after calcining the iron-manganese-based hydroxide precursor a resulting iron-manganese material maintains a charging capacity of at least 137.1 mAh per gram after 300 cycles of galvanostatic cycling at 1 C (175 mA/g) between 2 and 4 V.

27. The material of claim 22, wherein, after calcining the iron-manganese-based hydroxide precursor a resulting iron-manganese material maintains an average discharge voltage of 2.700 V after 300 cycles of galvanostatic cycling at 1 C (175 mA/g) between 2 and 4 V.

28. The material of claim 22, wherein, after calcining the iron-manganese-based hydroxide precursor a resulting iron-manganese material maintains an average discharge energy of 366.1 Wh per kilogram after 300 cycles of galvanostatic cycling at 1 C (175 mA/g) between 2 and 4 V.
